(19) United States
(12) Patent Application Publication
(10) Pub. No.: US 2016/0148090 A1
(43) Pub. Date: May 26, 2016

(54) SYSTEMS AND METHODS FOR CHANNEL IDENTIFICATION, ENCODING, AND DECODING MULTIPLE SIGNALS HAVING DIFFERENT DIMENSIONS

(71) Applicant: THE TRUSTEES OF COLUMBIA UNIVERSITY IN THE CITY OF NEW YORK, New York, NY (US)

(72) Inventors: Aurel A. Lazar, New York, NY (US); Yevgeniy B. Slutskiy, Brooklyn, NY (US)

(73) Assignee: THE TRUSTEES OF COLUMBIA UNIVERSITY IN THE CITY OF NEW YORK, New York, NY (US)

(21) Appl. No.: 14/948,884

(22) Filed: Nov. 23, 2015

Related U.S. Application Data
(63) Continuation of application No. PCT/US2014/039147, filed on May 22, 2014.
(60) Provisional application No. 61/826,319, filed on May 22, 2013.
(60) Provisional application No. 61/826,853, filed on May 23, 2013.
(60) Provisional application No. 61/828,957, filed on May 30, 2013.

(51) Int. Cl. G06N 3/02

(52) U.S. Cl. CPC G06N 3/02

(57) ABSTRACT

Systems and methods for channel identification, encoding and decoding signals, where the signals can have one or more dimensions, are disclosed. An exemplary method can include receiving the input signals and processing the input signals to provide a first output. The method can also encode the first output, at an asynchronous encoder, to provide encoded signals.

### CROSS-REFERENCE TO RELATED APPLICATIONS

This application is a continuation of International Patent Application No. PCT/US2014/039147, filed May 22, 2014, and claims priority of U.S. Provisional Application Ser. No. 61/826,319, filed on May 22, 2013; U.S. Provisional Application Ser. No. 61/826,853, filed on May 23, 2013; and U.S. Provisional Application Ser. No. 61/828,957, filed on May 30, 2013; each of which is incorporated herein by reference in its entirety and from which priority is claimed.

### STATEMENT REGARDING FEDERALLY-SPONSORED RESEARCH

This invention was made with government support under Grant No. FA9550-12-1-0232 awarded by the Air Force Office of Scientific Research and Grant No. R021 DCO 12440001 awarded by the National Institutes of Health. The government has certain rights in the invention.

### BACKGROUND

The disclosed subject matter relates to systems and techniques for channel identification machines, time encoding machines and time decoding machines.

Signal distortions introduced by a communication channel can affect the reliability of communication systems. Understanding how channels or systems distort signals can help to correctly interpret the signals sent. Multi-dimensional signals can be used, for example, to describe images, auditory signals, or video signals. These multi-dimensional signals can include spatial signals, where the input signal can be represented as a function of a two-dimensional space.

Certain technologies can provide techniques for encoding and decoding systems in a linear system, as well as for identifying nonlinear signal transformations introduced by a communication channel. However, there exists a need for an improved method for performing channel identification, encoding, and decoding in systems that transmit multiple signals that can have different dimensions.

### SUMMARY

Techniques for channel identification, encoding and decoding input signals, where the input signals have one or more dimensions are disclosed herein.

In one aspect of the disclosed subject matter, techniques for encoding input signals, where the input signals have one or more dimensions are disclosed. An exemplary method can include receiving the input signals. The method can also process the input signals to provide a first output. The method can further include encoding the first output, using asynchronous encoders, to provide the encoded signals.

In some embodiments, the first output can be a function of time. In some embodiments, the method can further include processing the input signals, using a kernel, into a second output for each of the input signals and aggregating the second output for each of the input signals to provide the first output.

In one aspect of the disclosed subject matter, techniques for decoding encoded signals are disclosed, where the encoded signals correspond to input signals having one or more dimensions. An exemplary method can include receiving the encoded signals and processing the encoded signals to produce output signals, where the output signals have one or more dimensions.

In some embodiments, the processing can include determining a sampling coefficient using the encoded signals. In other embodiments, the processing can further include determining a measurement using one or more times of the encoded signals. In some embodiments, the processing can further include determining a reconstruction coefficient using the sampling coefficient and the measurement, and constructing the output signals using the reconstruction coefficient and the measurement, where the output signals have one or more dimension.

In one aspect of the disclosed subject matter, techniques for identifying a processing performed by an unknown system using encoded signals, where the encoded signals are encoded from known input signals having one or more dimension, are disclosed. An exemplary method can include receiving the encoded signals and processing the encoded signals to produce output signals. The method can further include comparing the known input signals and the output signals to identify the processing performed by the unknown system.

### BRIEF DESCRIPTION OF THE DRAWINGS

The accompanying drawings, which are incorporated and constitute part of this disclosure, illustrate some embodiments of the disclosed subject matter.

FIG. 1A illustrates an exemplary system in accordance with the disclosed subject matter.

FIG. 1B illustrates an exemplary Time Encoding Machine (TEM) in accordance with the disclosed subject matter.

FIG. 1C illustrates an exemplary Time Decoding Machine (TDM) in accordance with the disclosed subject matter.

FIG. 1D illustrates an exemplary block diagram of an encoder unit in accordance with the disclosed subject matter,

FIG. 2 illustrates an exemplary block diagram of a decoder unit that can perform decoding on encoded signals in accordance with the disclosed subject matter.

FIG. 3A and FIG. 3B illustrate an exemplary method to encode one or more input signals, wherein the input signals have one dimension or have more than one dimension, in accordance with the disclosed subject matter.

FIG. 4A and FIG. 4B illustrate an exemplary and non-limiting illustration of an embodiment of a multisensory encoding according to the disclosed subject matter.

FIG. 5A, FIG. 5B, and FIG. 5C illustrate an exemplary and non-limiting illustration of a Multimodal TEM & TDM in accordance with the disclosed subject matter.

FIG. 6A and FIG. 6B illustrate an exemplary Multimodal CIM for audio and video integration.

FIG. 7A and FIG. 7B illustrate an exemplary multisensory decoding in accordance with the disclosed subject matter.

FIG. 8A and FIG. 8B illustrate an exemplary Multisensory identification in accordance with the disclosed subject matter.

FIG. 9 illustrates another exemplary multidimensional TEM system in accordance with the disclosed subject matter.

FIG. 10 illustrates another exemplary TEM in accordance with the disclosed subject matter.

FIG. 11 illustrates another exemplary TEM in accordance with the disclosed subject matter.

FIG. 12A and FIG. 12B illustrate another exemplary CIP in accordance with the disclosed subject matter.

FIG. 13 illustrates another exemplary CIM in accordance with the disclosed subject matter.

FIG. 14 illustrates performance of an exemplary spectro-temporal Channel Identification Machine in accordance with the disclosed subject matter.

FIG. 15 illustrates performance of another exemplary spatio-temporal Channel Identification Machine in accordance with the disclosed subject matter.

FIG. 16 illustrates performance of another exemplary spatio-temporal Channel Identification Machine in accordance with the disclosed subject matter.

FIGS. 17A-17I illustrate performance of another exemplary spatial Channel Identification Machine in accordance with the disclosed subject matter.

FIGS. 18A-18H illustrate an exemplary identification of spatiotemporal receptive fields in circuits with lateral connectivity and feedback in accordance with the disclosed subject matter.

### DESCRIPTION

Systems and methods for encoding and decoding multiple input signals having different dimensions are presented. The disclosed subject matter can encode input signals having different modalities that have different dimensions and dynamics into a single multidimensional output signal. The disclosed subject matter can decode input signals encoded as a single multidimensional output signal. The disclosed subject matter can also identify the multisensory processing in an unknown system. The disclosed subject matter can incorporate multiple input signals having different dimensions, such as, either one dimension or more than one dimension or a combination of both. For example, the disclosed subject matter can encode and decode a video signal and an audio signal. Furthermore, the systems and methods presented herein can utilize cross-coupling from other asynchronous encoders in the system. The disclosed subject matter can be applied to neural circuits, asynchronous circuit design, communication systems, signal processing, neural prosthetics and brain-machine interfaces, or the like.

As referenced herein, the term “spike” or “spikes” can refer generally to electrical pulses or action potentials, which can be received or transmitted by a spike-processing circuit, The spike-processing circuit can include, for example and without limitation, a neuron or a neuronal circuit. References to “one example,” “one embodiment,” “an example,” or “an embodiment” do not necessarily refer to the same example or embodiment, although they may. It should be understood that channel identification can refer to identifying processing performed by an unknown system.

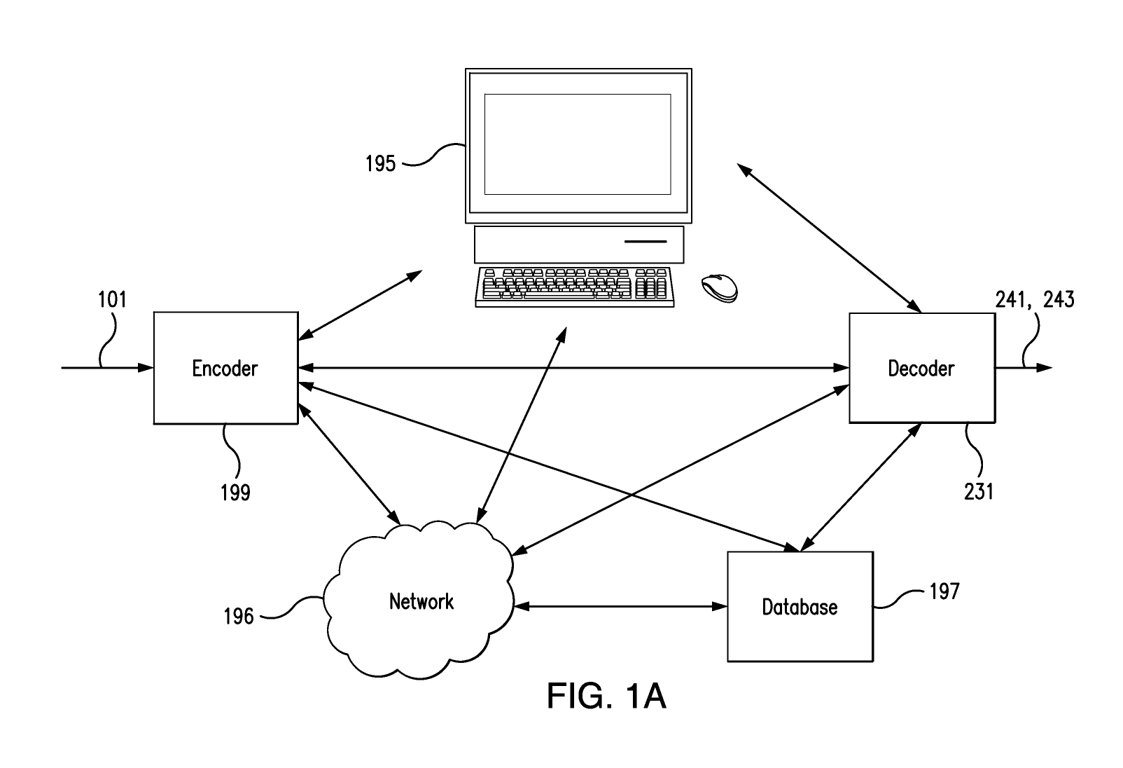

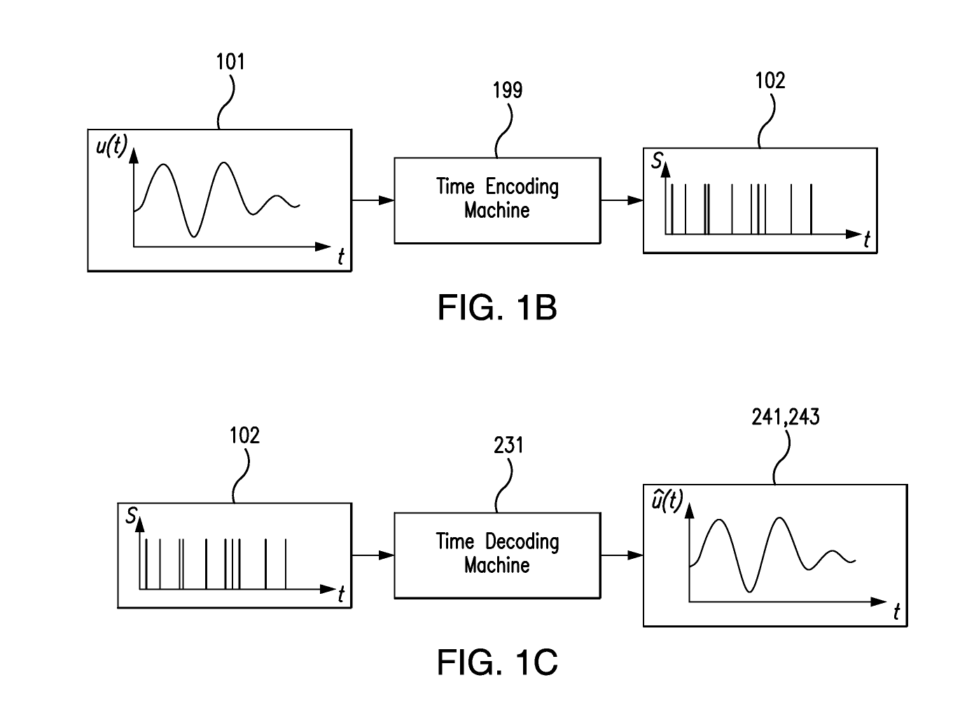

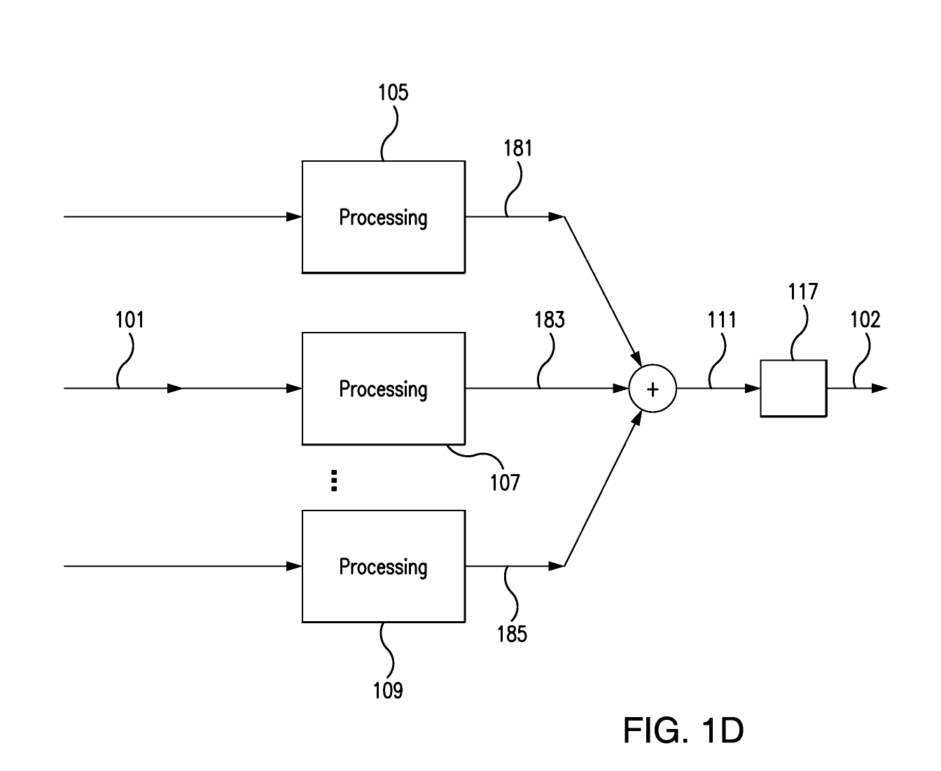

FIG. 1A illustrates an exemplary system in accordance with the disclosed subject matter. With reference to FIG. 1A, multiple input signals 101, are received by an encoder unit 199. In one example, the input signals can have different dimensions. For example, the input signals can have one dimension, such as a function of time (t). In another example, one of the input signals can have more than one dimension, e.g., a video signal can be a function of space (x,y) and time (t). In another example, the input signals can include a combination of at least one input signal having one dimension, and at least one input signal having more than one dimension. As such, the input signals can include an audio signal, which is a function of time, and a video signal, which is a function of space and time. It should be understood that multimodal signals can include one or more one dimensional signals, one or more multi-dimensional signals, or a combination thereof.

As further illustrated in FIG. 1A, the encoder unit 199 can encode the input signals 101 and provide the encoded signals to a control unit or a computer unit 195. The encoded signals can be digital signals that can be read by a control unit 195. The control unit 195 can read the encoded signals, analyze, and perform various operations on the encoded signals. The encoder unit 199 can also provide the encoded signals to a network 196. The network 196 can be connected to various other control units 195 or databases 197. The database 197 can store data regarding the signals 101 and the different units in the system can access data from the database 197. The database 197 can also store program instructions to run programs that implement methods in accordance with the disclosed subject matter. The system also includes a decoder 231 that can decode the encoded signals, which can be digital signals, from the encoder unit 199. The decoder 231 can recover the analog signal 101 encoded by the encoder unit 199 and output an analog signal 241, 243 accordingly. The control unit 195 can be an analog circuit, such as a low-power analog VLSI circuit, The control unit 195 can be a neural network such as a recurrent neural network.

For purposes of this disclosure, the database 197 and the control unit 195 can include random access memory (RAM), storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory. The control unit 195 can further include a processor, which can include processing logic configured to carry out the functions, techniques, and processing tasks associated with the disclosed subject matter. Additional components of the database 197 can include one or more disk drives. The control unit 195 can include one or more network ports for communication with external devices. The control unit 195 can also include a keyboard, mouse, other input devices, or the like. A control unit 195 can also include a video display, a cell phone, other output devices, or the like. The network 196 can include communications media such wires, optical fibers, microwaves, radio waves, and other electromagnetic and/or optical carriers; and/or any combination of the foregoing.

FIG. 1B illustrates an exemplary Time Encoding Machine (TEM) in accordance with the disclosed subject matter. It should be understood that a TEM can also be understood to be an encoder unit 199. In one embodiment, Time Encoding Machines (TEM) can process and encode one or more input signals. In one example, the input signals can have one dimension, for example, the input signals can be a function of time (t). In another example, one of the input signals can have more than one dimension, for example, a video signal can be a function of space (x,y) and time (t). In another example, the input signals can include a combination of at least one input signal having one dimension and at least one input signal having more than one dimension. For example, the input signals can include an audio signal, which is a function of time and a video signal, which is a function of space and time.

As further illustrated in FIG. 1B, a TEM 199 can be a device which encodes analog signals 101 as monotonically increasing sequences of irregularly spaced times 102. A TEM 199 can output, for example, spike time signals 102, which can be read by computers. In one example, the output can be a function of one dimension. For example, the output can be a function of time.

With further reference to FIG. 1B, in one example, TEMs 199 can be real-time asynchronous apparatuses that encode analog signals into a time sequences. They can encode analog signals into an increasing sequence of irregularly-spaced times (tₖ)_{kεZ}, where k can be defined as the index of the spike (pulse) and tₖ can be the timing of that spike. In one embodiment, they can be similar to irregular (amplitude) samplers and, due to their asynchronous nature, are inherently low-power devices. TEMs 199 are also readily amenable to massive parallelization, allowing fundamentally slow components to encode rapidly varying stimuli, i.e., stimuli with large bandwidth. Furthermore, TEMs 199 can represent analog signals in the time domain. Furthermore, given the parameters of the TEM 199 and the time sequence at its output, a time decoding machine (TDM) can recover the encoded multi-dimensional signals loss-free.

In one embodiment, the TEM 199 can encode several signals having different modalities. In one example, the exemplary TEM 199 can allow for (a) built-in redundancy, where by rerouting, a circuit can take over the function of a faulty circuit, (b) capability to encode one signal, a proper subset of signals or an entire collection of signals upon request, (c) capability to dynamically allocate resources for the encoding of a given signal or signals of interest, (d) joint storage of multimodal signals or stimuli and (e) joint processing of multimodal signals or stimuli without an explicit need for synchronization. In one embodiment, a Multiple Input, Multiple Output (MIMO) TEM 199 can be used to enable the encoding of multiple signals having different modalities simultaneously. In one embodiment, a multimodal TEM 199 can encode a function of time (e.g., an audio signal) and a function of space-time (e.g., a video signal) simultaneously.

FIG. 1C illustrates an exemplary Time Decoding Machine (TDM) in accordance with the disclosed subject matter. It should be understood that a TDM can also be understood to be a decoder unit 231. In one embodiment, Time Decoding Machines (TDMs) can reconstruct time encoded input signals from spike trains. In one example, the input signals can have one dimension, for example, the input signals can be a function of time (t). In another example, one of the input signals can have more than one dimension, for example, a video signal can be a function of space (x,y) and time (t). In another example, the input signals can include a combination of at least one input signal having one dimension and at least one input signal having more than one dimension. For example, the input signals can include an audio signal, which is a function of time and a video signal, which is a function of space and time. The encoded signals or spike trains can have one dimension, for example, the encoded signal can be a function of time. In one example, the input signal can be encoded by a single neuron or a single sampler, which can produce a single spike train. In another example, the input signal can be encoded by multiple neurons, which can produce multiple spike trains. In another example, the multiple spike trains can be combined into a single spike train.

With reference to FIG. 1C, a TDM 231 is a device which constructs the Time Encoded signals 102 into one or more input signals 241, 243 which can be actuated on the environment. It should be understood that the reconstructed one or more input signals can be a function of one dimension or a function of more than one dimension, or a combination of both.

In one example, the Time Decoding Machines 231 can recover the signal loss-free. A TDM can be a realization of an algorithm that recovers the analog signal from its TEM counterpart. In one embodiment, Multimodal TDMs 231 can be used that allow recovery of the original multimodal signals. In another embodiment, multimodal TEMs 199 or multimodal TDMs 231 can incorporate both linear and nonlinear processing of signals.

FIG. 1D illustrates an exemplary block diagram of an encoder unit 199 in accordance with the disclosed subject matter. In one embodiment, the input signal 101 is provided as an input to one or more processors 105, 107, 109. In another embodiment, more than one input signals 101 can be used. In one example, the input signals 101 can be one dimensional, for example, the input signals can be a function of time (t). In another example, one of the input signals 101 can have more than one dimension, for example, a video signal can be a function of space (x,y) and time (t). In another example, the input signals 101 can include a combination of at least one input signal 101 of a one dimension and at least one input signal 101 of more than one dimension. The outputs 181, 183, 185 from the processors 105, 107, 109 can be summed 111 and provided as an input to an asynchronous encoder 117. The asynchronous encoder 117 can encode the input 111 into encoded signal 102. The encoded signal can be a one-dimensional signal, for example, a function of time.

As further illustrated in FIG. 1D, the asynchronous encoder 117 can include, but is not limited to conductance-based models such as Hodgkin-Huxley, Morris-Lecar, Fitzhugh-Nagumo, Wang-Buzsaki, Hindmarsh-Rose, ideal integrate-and-fire (IAF) neurons, or leaky IAF neurons as those of ordinary skill in the art will appreciate. The asynchronous encoder 117 can also include, but is not limited to, oscillator with multiplicative coupling, oscillator with additive coupling, integrate-and-fire neuron, threshold and fire neuron, irregular sampler, analog to digital converter, such as, an Asynchronous Sigma-Delta Modulator (ASDM), pulse generator, time encoder, or pulse-domain Hadamard gate, or the like. It should be understood that an asynchronous encoder 117 can also be known as an asynchronous sampler. In another example, asynchronous encoders can work either independently of each other, or they can be cross-coupled. In one example, in a single-input, multiple-output (SIMO) or a multiple-input, multiple-output (MIMO) system, the asynchronous encoders can work either independently of each other, or they can be cross-coupled. In another example, the output encoded signal 102 can be provided as a feed-back and this output along with the cross-coupling from other asynchronous encoders 117 can be added to provide the spike train output or the encoded signal 102.

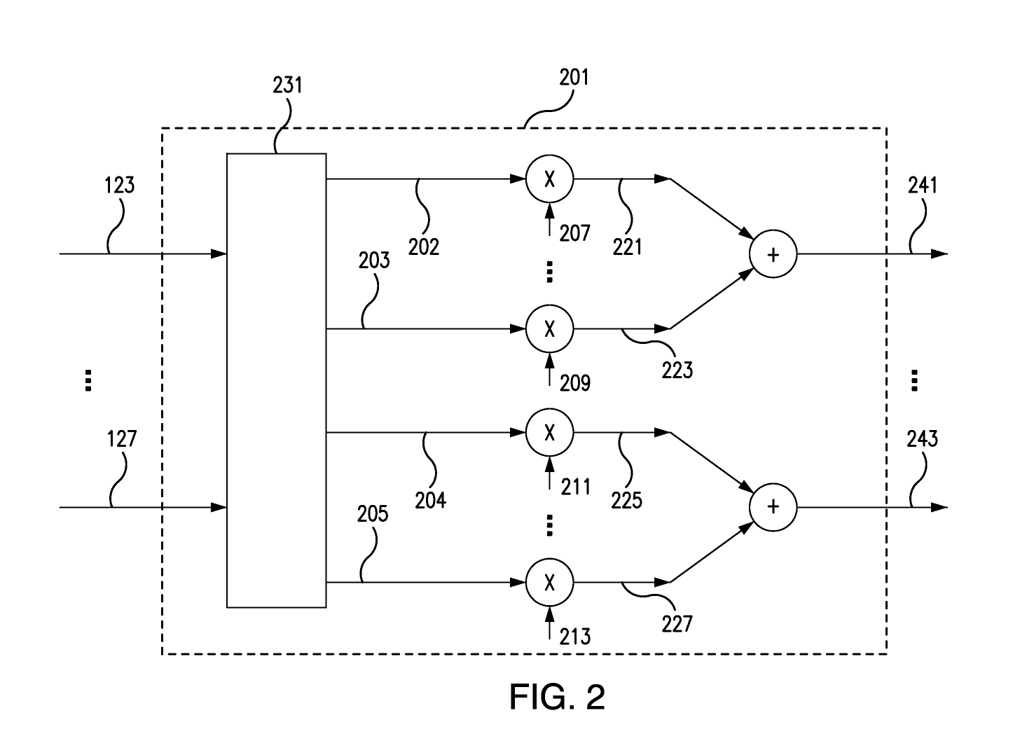

FIG. 2 illustrates an exemplary block diagram of a decoder unit 231 that can perform decoding on encoded signals 123, 127 in accordance with the disclosed subject matter. With reference to FIG. 2, encoded signals 123, 127 are received by the decoding unit 231. In one example, the encoded signals 123, 127 can be spike trains. In another example, the encoded signals 123, 127 can be a function of one dimension, for example, the encoded signals 123, 127 be a function of time. In another example, the encoded signals 123, 127 can be combined into a single spike train signal.

As further illustrated in FIG. 2, an exemplary operation 201 can be performed on the encoded signals that results in coefficients 202, 203, 204, 205. Examples of the operation 201 include, but are not limited to, taking a pseudo-inverse of a matrix, multiplying matrices, solving an optimization problem, such as a convex optimization problem, or the like. It should be understood that a matrix can also be referred to as a sampling coefficient. The coefficients 202, 203, 204, 205 of the operation 201 can be multiplied by functions 207, 209, 211, 213. Functions 207, 209, 211, 213 can be basis functions. The result of this operation 221, 223 and 225, 227 can be aggregated or summed together to form output reconstructed signals 241 . . . 243.

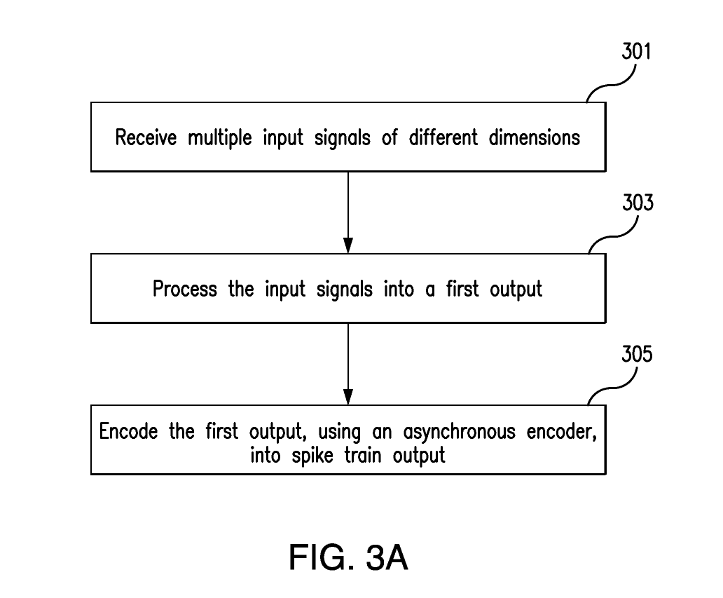

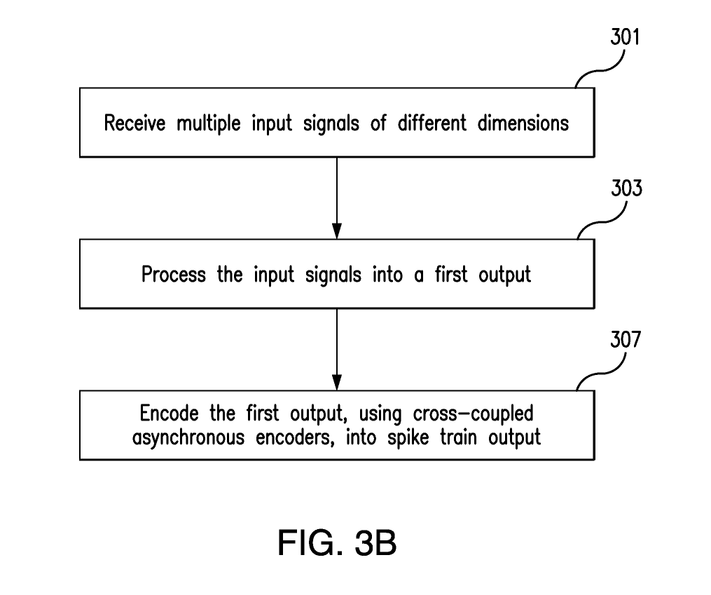

FIG. 3A and FIG. 3B illustrate an exemplary method to encode one or more input signals, wherein the input signals have one dimension or have more than one dimensions, in accordance with the disclosed subject matter. In one example, the input signals 301 can be one dimensional, for example, the input signals can be a function of time (t). In another example, one of the input signals 301 can be more than one dimension, for example, a video signal can be a function of space (x,y) and time (t). In another example, the input signals 101 can include a combination of at least one input signal 101 having a one dimension and at least one input signal 101 having more than one dimension. For example, the input signals 101 can include an audio signal, which is a function of time and a video signal, which is a function of space and time. In one example, the encoder unit 199 receives the input signals 101 (301). The encoder unit 199 then processes 105, 107, 109 the signals (303). In one example, the output of the processing 105, 107, 109 can be added together. The encoder unit 199 then encodes the output from the processing, using an asynchronous encoder 117, into an encoded signal output 123, 127—or a spike train output 102 (305). In one example, the encoded signal output 123, 127 can have one dimension, for example, time. As illustrated in FIG. 33, the output from the encoder unit 199 can be cross-coupled (307). As such, the output from the encoder unit 199 and other encoder units 199 can be added to provide a spike train output (307).

### EXAMPLE 1

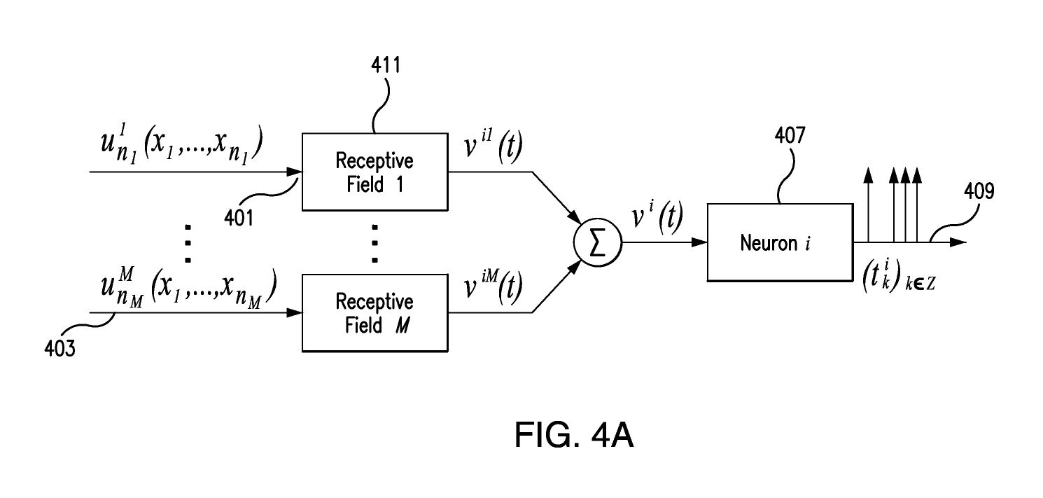

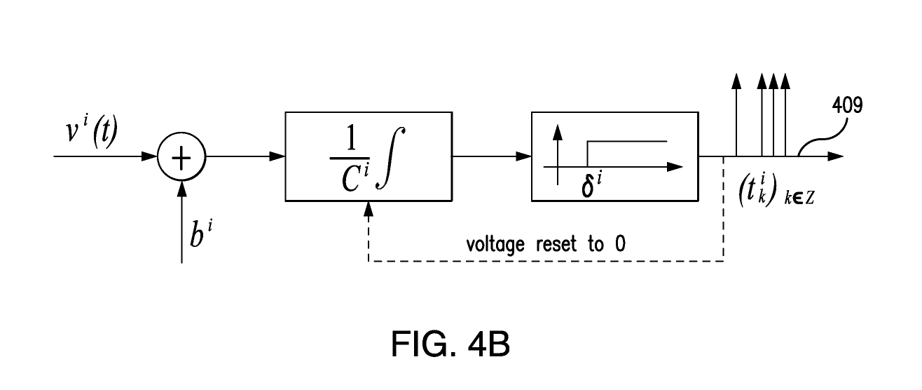

For purpose of illustration and not limitation, exemplary embodiments of the disclosed subject matter will now be described. FIG. 4A and FIG. 4B illustrate an exemplary and non-limiting illustration of an embodiment of a multisensory encoding system according to the disclosed subject matter. In the exemplary multisensory encoding, each neuron 407 i=1, . . . , N can receive multiple stimuli 401, 403 uₙ_{ₘ}^{m}, m=1, . . . , M of different modalities and can encode them into a single spike train 409 (tₖⁱ)_{kεZ}. FIG. 4B illustrates an exemplary multisensory encoding system where a spiking point neuron 407 model, for example, the IAF model, can describe the mapping of the current vⁱ(t)=Σₘv^{im}(t) into spikes 409.

In one example, a multisensory encoding can be real-time asynchronous mechanisms for encoding continuous and discrete signals into a time sequence. It should be understood that a multisensory encoding can also be known as a multisensory Time Encoding Machine (mTEM). Additionally or alternatively, TEMs can be used as models for sensory systems in neuroscience as well as nonlinear sampling circuits and analog-to-discrete (A/D) converters in communication systems. However, as depicted in FIG. 4A, in contrast to a TEM that can encode one or more stimuli 401, 403 of the same dimension n, an exemplary mTEM can receive M input stimuli 401, 403 uₙ_{₁}¹, . . . , uₙ_{_{M}}^{M} of different dimensions nₘεN, m=1, . . . , M, as well as different dynamics. For example, the exemplary mTEM can process a video input signal and an audio input signal. Additionally, the mTEM can process 411 and encode these signals into a multidimensional spike train 409 using a population of N neurons 407. For each neuron 407 i=1, . . . , N, the results of this processing can be aggregated into the dendritic current vⁱ flowing into the spike initiation zone, where it can be encoded into a time sequence 409 (tₖⁱ)_{kεZ}, with tₖⁱ denoting the timing of the k^{th} spike of neuron i.

With reference to FIG. 4A and FIG. 4B, mTEMs can employ a myriad of spiking neuron models. In this example, an ideal IAF neuron is used. However, it should be understood that other models can be used instead of an ideal IAF neuron.

For purpose of illustration, an ideal IAF neuron with a bias bⁱεR₊, capacitance CⁱεR₊ and threshold δⁱεR₊, the mapping of the current vⁱ into spikes can be described by a set of equations formerly known as the t-transform:

∫ₜ_{ₖ}_{ⁱ}^{t}^{ₖ₊₁}^{ⁱ}vⁱ(s)ds=qₖⁱ, kεZ, (1)

where qₖⁱ=Cⁱδⁱ−bⁱ(tₖ₊₁ⁱ−tₖⁱ). In one example, at every spike time tₖ₊₁ⁱ, the ideal IAF neuron can be providing a measurement qₖⁱ of the current vⁱ(t) on the time interval [tₖⁱ,tₖ₊₁ⁱ).

### EXAMPLE 2

In one example, an exemplary sensory input in accordance with the disclosed subject matter can be modeled. For purpose of illustration, the input signals are modeled as elements of reproducing kernel Hilbert spaces (RKHSs). Certain signals, including, for example, natural stimuli, can be described by an appropriately chosen RKHS. In this example, the space of trigonometric polynomials Hₙ_{ₘ} is used, where each element of the space is a function in nₘ variables (nₘεN, m=1, 2, . . . , M). However, it should be understood that other methods of modeling the sensor inputs, other than RKHS can be used.

For purpose of illustration, an exemplary sensory input can be represented using:

The space of trigonometric polynomials Hₙ_{ₘ} can be a Hilbert space of complex-valued functions, which can be defined as:

$${u}_{{n}_{m}}^{m} ( {x}_{1} , … , {{x}_{n}}_{m} ) = {\sum }_{{l}_{1} = {L}_{1}}^{{L}_{1}} … {\sum }_{{l}_{{n}_{m}} = - {L}_{{n}_{m}}}^{{L}_{{n}_{m}}} {u}_{{l}_{1} … {l}_{{n}_{m}}}^{m} {e}_{{l}_{1} … {l}_{{n}_{m}}} ( {x}_{1} , … , {x}_{{n}_{m}} ) , \qquad ( 2 )$$

over the domain Dₙ_{ₘ}=Πₙ₌₁ⁿ^{ₘ}[0,Tₙ], where

$${u}_{{l}_{1 } … {l}_{{n}_{m}}}^{m} ∈ C$$

and the functions

$${e}_{{l}_{1} … {l}_{{n}_{m}}} ( {x}_{1} , … , {x}_{{n}_{m}} ) = exp ( {\sum }_{n = 1}^{{n}_{m}} j {l}_{n} {Ω}_{n} {x}_{n} \text{/} {L}_{n} ) \text{/} \sqrt{{T}_{1} … {T}_{{n}_{m}}} ,$$

with j denoting the imaginary number. Here Ωₙ is the bandwidth, Lₙ is the order, and Tₙ=2πLₙ/Ωₙ is the period in dimension xₙ. Hₙ_{ₘ} is endowed with the inner product [symbol] •,• [symbol] :Hₙ_{ₘ}×Hₙ_{ₘ}→C, where

$$〈 {u}_{{n}_{m}}^{m} , {w}_{{n}_{m}}^{m} 〉 = {\int }_{{D}_{{n}_{m}}} {u}_{{n}_{m}}^{m} ( {x}_{1} , … , {x}_{{n}_{m}} ) \overline{{w}_{{n}_{m}}^{m} ( {x}_{1} , … , {x}_{{n}_{m}} )} d {x}_{1} … d {x}_{{n}_{m}} . \qquad ( 3 )$$

Given the inner product in Equation 3, the set of elements

$${e}_{{l}_{1} … {l}_{{n}_{m}}} ( {x}_{1} , … , {x}_{{n}_{m}} )$$

can form an orthonormal basis in Hₙ_{ₘ}. Moreover, Hₙ_{ₘ} is an RKHS with the reproducing kernel (RK)

$${K}_{{n}_{m}} ( {x}_{1} , … , {{x}_{n}}_{m} ; {y}_{1} , … , {{y}_{n}}_{m} ) = {\sum }_{{l}_{1} = - {L}_{1}}^{{L}_{1}} {\sum }_{{l}_{{n}_{m}} = - {L}_{{n}_{m}}}^{{L}_{{n}_{m}}} {e}_{{l}_{1} … {l}_{{n}_{m}}} ( {x}_{1} , … , {{x}_{n}}_{m} ) \overline{{e}_{{l}_{1} … {l}_{{n}_{m}}} ( {y}_{1} , … , {y}_{{n}_{m}} )} . \qquad ( 4 )$$

In this example, time-varying stimuli is used and the dimension xₙ_{ₘ} can denote the temporal dimension t of the stimulus uₙ_{ₘ}^{m}, i.e., xₙ_{ₘ}=t.

Furthermore, in one example, for M concurrently received stimuli, Tₙ_{₁}=Tₙ_{₂}= . . . =Tₙ_{_{M}}.

### EXAMPLE 2.1

For purpose of illustration and not limitation, audio stimuli u₁^{m}=u₁^{m}(t) can be modeled as elements of the RKHS H₁ over the domain D₁=[0,T₁]. For example, the dimensionality subscript is dropped and T, Ω and L can be used, to denote the period, bandwidth and order of the space H₁. An audio signal u₁^{m}εH₁ can be written as u₁^{m}(t)=Σ_{l=-L}^{L}uₗ^{m}eₗ(t), where the coefficients uₗ^{m}εC and eₗ(t)=exp(jlΩt/L)/\sqrt{T}.

### EXAMPLE 2.2

In one embodiment, video stimuli u₃^{m}=u₃^{m}(x,y,t) can be modeled as elements of the RKHS H₃ defined on D₃=[0,T₁]×[0,T₂]×[0,T₃], where T₁=2πL₁/Ω₁, T₂″2πL₂/Ω₂, T₃=2πL₃/Ω₃, with (Ω₁,L₁), (Ω₂,L₂) and (Ω₃,L₃) denoting the (bandwidth, order) pairs in spatial directions x, y and in time t, respectively. Furthermore, a video signal u₃^{m}εH₃ can be written as u₃^{m}(x,y,t)=Σₗ_{₁}_{=-L}_{₁}^{L}^{₁}Σₗ_{₂}_{=-L}_{₂}^{L}^{₂}Σₗ_{₃}_{=-L}_{₃}^{L}^{₃}Σuₗ_{₁}ₗ_{₂}ₗ_{₃}eₗ_{₁}ₗ_{₂}ₗ_{₃}(x,y,t), where the coefficients uₗ_{₁}ₗ_{₂}ₗ_{₃}^{m}εC and the functions can be defined as

eₗ_{₁}ₗ_{₂}ₗ_{₃}(x,y,t)=exp(jl₁Ω₁x/L₁+jl₂Ω₂y/L₂+jl₃Ω₃t/L₃)/\sqrt{T₁T₂T₃}. (5)

### EXAMPLE 3

For purpose of illustration and not limitation, an exemplary sensory processing in accordance with the disclosed subject matter is described herein. For example, and as embodied herein, multisensory processing can be described by a nonlinear dynamical system capable of modeling linear and nonlinear stimulus transformations, including cross-talk between stimuli. In this example, linear transformations that can be described by a linear filter having an impulse response, or kernel, hₙ_{ₘ}^{m}(x₁, . . . , xₙ_{ₘ}) are considered. It should be understood that non-linear and other transformations can be used as well. In this example, the kernel is assumed to be bounded-input bounded-output (BIBO)-stable and causal. It can be assumed that, for example, such transformations involve convolution in the time domain (temporal dimension xₙ_{ₘ}) and integration in dimensions x₁, . . . , xₙ_{ₘ}₋₁. It can also be assumed that the kernel has a finite support in each direction xₙ, n=1, . . . , nₘ. In other words, the kernel hₙ_{ₘ}^{m} belongs to the space Hₙ_{ₘ} defined below.

For purpose of illustration, an exemplary sensory input can be represented using:

The filter kernel space can be defined as

Hₙ_{ₘ}={hₙ_{ₘ}^{m}εL¹(Rⁿ^{ₘ})|supp(hₙ_{ₘ}^{m})⊂Dₙ_{ₘ}}. (6)

The projection operator can be defined as P:Hₙ_{ₘ}→Hₙ_{ₘ} can be given (for example, by abuse of notation) by

(Phₙ_{ₘ}^{m})(x₁, . . . , xₙ_{ₘ})= [symbol] hₙ_{ₘ}^{m}(•, . . . , •),Kₙ_{ₘ}(•, . . . , •;x₁, . . . , xₙ_{ₘ}) [symbol] . (7)

### Since

$${Ph}_{{n}_{m}}^{m} ∈ {H}_{{n}_{m}} , ( {Ph}_{{n}_{m}}^{m} ) ( {x}_{1} , … , {x}_{{n}_{m}} ) = {\sum }_{{l}_{1} = - {L}_{1}}^{{L}_{1}} … {\sum }_{{l}_{{n}_{m}} = - {L}_{{n}_{m}}}^{{L}_{{n}_{m}}} {h}_{{l}_{1} … {l}_{{n}_{m}}}^{m} {e}_{{l}_{1} … {l}_{{n}_{m}}} ( {x}_{1} , … , {x}_{{n}_{m}} ) .$$

### EXAMPLE 4

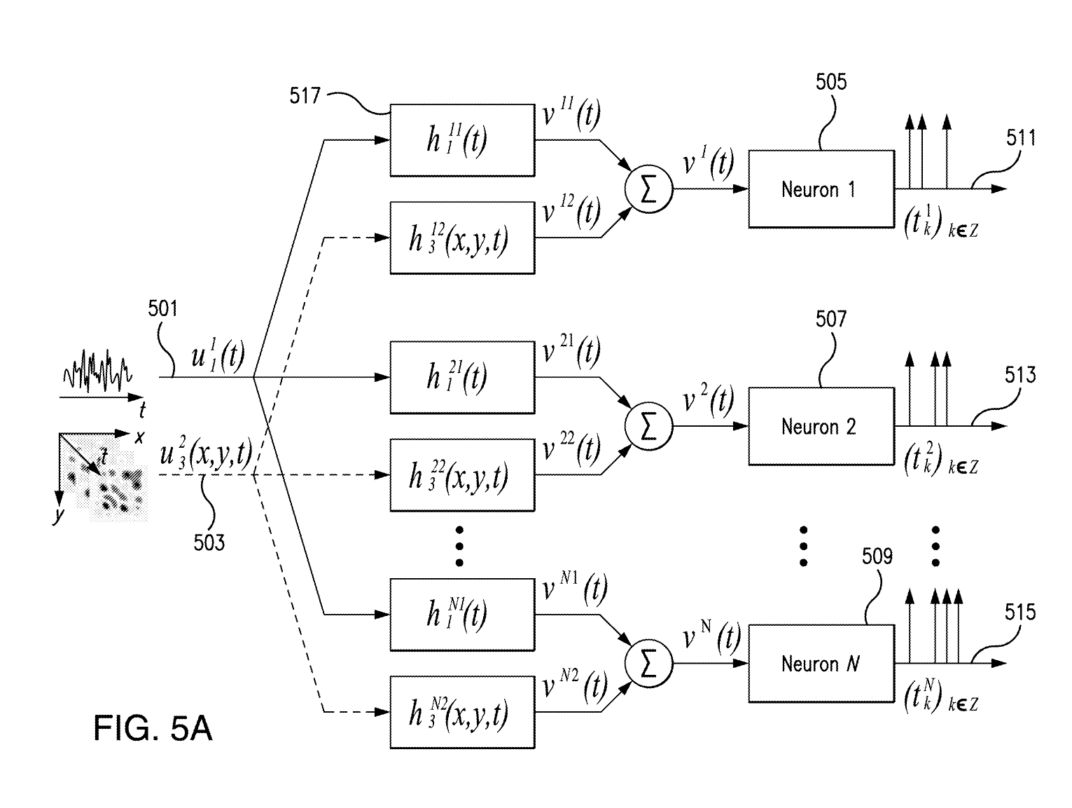

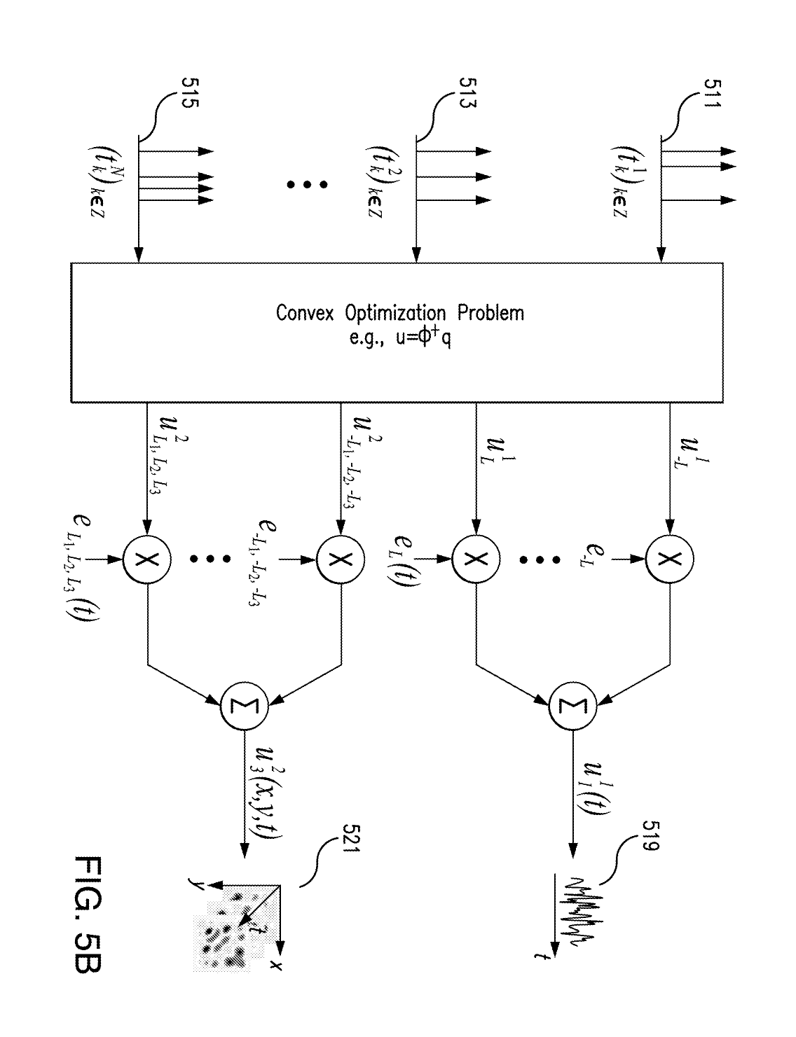

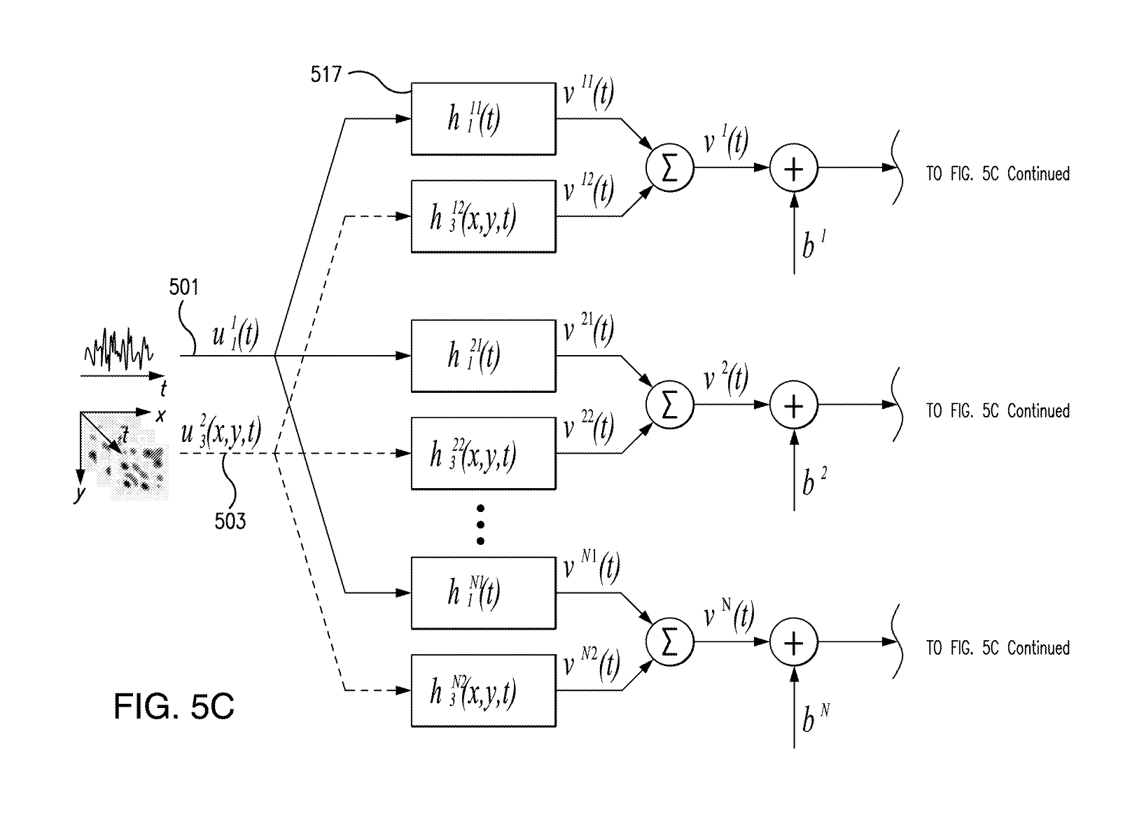

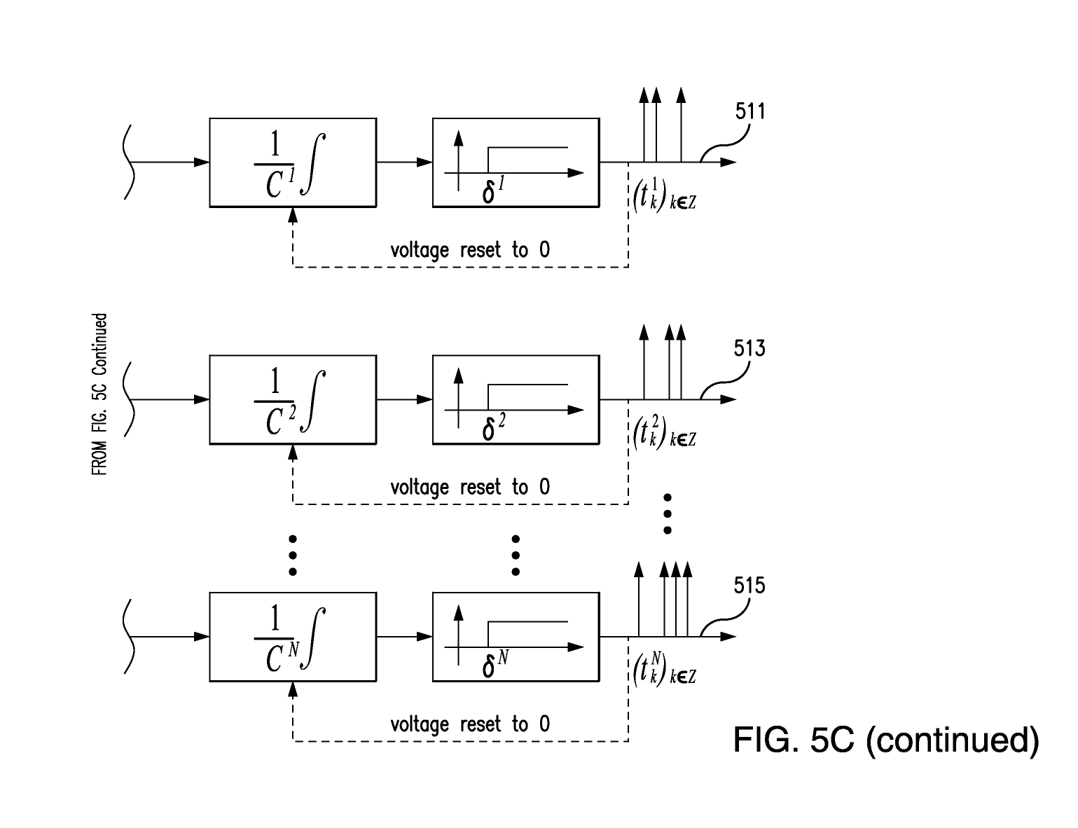

FIG. 5A, FIG. 5B, and FIG. 5C illustrate an exemplary and non-limiting illustration of a Multimodal TEM & TDM in accordance with the disclosed subject matter. In one example, the Multimodal TEM and TDM can be used for audio and video integration. FIG. 5A depicts an exemplary block diagram of the multimodal TEM. FIG. 5B illustrates an exemplary block diagram of a multimodal TDM in accordance with the disclosed subject matter. FIG. 5C illustrates another exemplary block of a multimodal TEM in accordance with the disclosed subject matter.

The exemplary mTEM described herein can be comprised of a population of N ideal IAF neurons 505, 507, 509 receiving M input signals 501, 503 uₙ_{ₘ}^{m} of dimensions nₘ, m=1, . . . , M. In this example, it can be assumed that the multisensory processing is given by kernels 517 hₙ_{ₘ}^{im}, m=1, . . . , M, i=1, . . . , N. As such, the t-transform in Equation 1 can be rewritten as:

Tₖⁱ¹[uₙ_{₁}¹]+Tₖⁱ²[uₙ_{₂}²]+ . . . +Tₖ^{iM}[uₙ_{_{M}}^{M}]=qₖⁱ, kεZ, (8)

where Tₖ^{im}:Hₙ_{ₘ}→R are linear functional that can be defined by

$${T}_{k}^{im} [ {u}_{{n}_{m}}^{m} ] = {\int }_{{l}_{k}^{i}}^{{l}_{k + 1}^{i}} [ {\int }_{{D}_{{n}_{m}}} {h}_{{n}_{m}}^{im} ( {x}_{1} , … , {x}_{{n}_{m} - 1} , s ) {u}_{{n}_{m}}^{m} ( {x}_{1} , … , {x}_{{n}_{m} - 1} , t - s ) d {x}_{1} … d {x}_{{n}_{m} - 1} d s ] d t . \qquad ( 9 )$$

In one example, each qₖⁱ in Equation 8 can be a real number representing a quantal measurement of all M stimuli, taken by the neuron i on the interval [tₖⁱ,tₖ₊₁ⁱ). These measurements can be produced, for example, in an asynchronous fashion and can be computed directly from spike times 511, 513, 515 (tₖⁱ)_{kεZ} using Equation 1. For purposes of illustration, a stimuli 519, 521, uₙ_{ₘ}^{m}, m=1, . . . , M can be reconstructed from (tₖⁱ)_{kεZ}, i=1, . . . , N.

For purpose of illustration, an exemplary Multisensory Time Decoding Machine (mTDM) can be represented using the following equations and exemplary theorem:

In an exemplary Multisensory Time Decoding Machine (mTDM), M signals 501, 503 uₙ_{ₘ}^{m}εHₙ_{ₘ} can be encoded by a multisensory TEM comprised of N ideal IAF neurons 505, 507, 509 and N×M receptive fields 517 with full spectral support. In this example, it can be assumed that the IAF neurons 505, 507, 509 do not have the same parameters, and/or the receptive fields 517 for each modality are linearly independent. Then given the filter kernel coefficients,

$${h}_{{l}_{1} … {l}_{{n}_{m}}}^{m} ,$$

i=1, . . . , N, all inputs 519, 521 uₙ_{ₘ}^{m} can be perfectly recovered as

$${u}_{{n}_{m}}^{m} ( {x}_{1} , … , {{x}_{n}}_{m} ) = {\sum }_{{l}_{1} = - {L}_{1}}^{{L}_{1}} … {\sum }_{{l}_{{n}_{m}} = - {L}_{{n}_{m}}}^{{L}_{{n}_{m}}} {u}_{{l}_{1} … {l}_{{n}_{m}}}^{m} {e}_{{l}_{1} … {l}_{{n}_{m}}} ( {x}_{1} , … , {x}_{{n}_{m}} ) , \qquad ( 10 )$$

where

$${u}_{{l}_{1} … {l}_{{n}_{m}}}^{m}$$

can be elements of u=Φ⁺q, and Φ⁺ denotes the pseudo-inverse of Φ. Furthermore, Φ=[Φ¹;Φ²; . . . ; Φ^{N}], q=[q¹;q²; . . . ; q^{N}] and [qⁱ]ₖ=qₖⁱ. Each matrix Φⁱ=[Φⁱ¹,Φⁱ², . . . , Φ^{im}], with

$${[ {Φ}^{im} ]}_{kl} = \{ \begin{matrix}{h}_{- {l}_{1} , - {l}_{2} , … , - {l}_{{n}_{m} - 1} , {l}_{{n}_{m}}}^{im} ( {t}_{k + 1}^{i} - {t}_{k}^{i} ) , & {l}_{{n}_{m}} = 0 \\ \frac{{h}_{- {l}_{1} , - {l}_{2} , … , - {l}_{{n}_{m} - 1} , {l}_{{n}_{m}}}^{im} {L}_{{n}_{m}} \sqrt{{T}_{{n}_{m}}} ( {e}_{{l}_{{n}_{m}}} ( {t}_{k + 1}^{i} ) - {e}_{{l}_{{n}_{m}}} ( {t}_{k}^{i} ) )}{j {l}_{{n}_{m}} {Ω}_{{n}_{m}}} , & {l}_{{n}_{m}} \neq 0\end{matrix} , \qquad ( 11 )$$

where the column index l can traverse all subscript combinations of l₁, l₂, . . . , lₙ_{ₘ}. In one example, a necessary condition for recovery can be that the total number of spikes generated by all neurons is larger than Σₘ₌₁^{M}Πₙ₌₁ⁿ^{ₘ}(2Lₙ+1)+N. If each neuron produces v spikes in an interval of length Tₙ_{₁}=Tₙ_{₂}= . . . =Tₙ_{_{M}}, a sufficient condition can be represented by N≧|Σₘ₌₁^{M}Πₙ₌₁ⁿ^{ₘ}(2Lₙ+1)/min(v−1,2Lₙ_{ₘ}+1)|, where ┌x┐ denotes the smallest integer greater than x.

For purposes of illustration an exemplary proof can substitute Equation 10 into Equation 8 to provide:

$${q}_{k}^{i} = {T}_{k}^{i 1} [ {u}_{{n}_{1}}^{1} ] + … + {T}_{k}^{iM} [ {u}_{{u}_{M}}^{M} ] = 〈 {u}_{{u}_{M}}^{M} , {φ}_{{n}_{M} k}^{iM} 〉 = {\sum }_{{l}_{1}} {\sum }_{{l}_{{n}_{1}}} {u}_{- {l}_{1} , - {l}_{2} , - {l}_{{n}_{1} - 1} , {l}_{{n}_{1}}}^{1} \overline{{φ}_{{l}_{1} … {l}_{{n}_{1}} k}^{i 1}} + … + {\sum }_{{l}_{1}} … {\sum }_{{l}_{{n}_{M}}} {u}_{- {l}_{1} , - {l}_{2} , - {l}_{{n}_{M}} - 1 , {l}_{{n}_{M}}}^{M} \overline{{φ}_{{l}_{1} … {l}_{{n}_{M}} k}^{iM}} , \qquad ( 13 )$$

where kεZ and the second equality can follow from the Riesz representation theorem with φₙ_{ₘ}ₖ^{im}εHₙ_{ₘ}, m=1, . . . , M. In this example, in matrix form the above equality can be written as qⁱ=Φⁱu, with [qⁱ]ₖ=qₖⁱ, Φⁱ=[Φⁱ¹,Φⁱ², . . . , Φ^{iM}], where elements [Φ^{im}]ₖₗ are given by

$${[ {Φ}^{im} ]}_{kl} = {φ}_{{l}_{1} … {l}_{{n}_{M}} k}^{im} ,$$

with index l traversing all subscript combinations of l₁, l₂, . . . , lₙ_{ₘ}. To find the coefficients

$$\overline{{φ}_{{l}_{1} … {l}_{{n}_{m}} k}^{im}} , {φ}_{{l}_{1} … {l}_{{n}_{m}} k}^{im} = \overline{{T}_{{n}_{m} k}^{im} ( {e}_{{l}_{1} … {l}_{{n}_{m}}} )} , m = 1 , … , M , i = 1 , … , N .$$

m=1, . . . , M, i=1, . . . , N. The column vector u=[u¹;u²; . . . ; u^{m}] with the vector u^{m} containing Πₙ₌₁ⁿ^{ₘ}(2Lₙ+1) entries corresponding to coefficients

$${u}_{{l}_{1} {l}_{2} … {l}_{{n}_{m}}}^{m} .$$

Furthermore, repeating for all neurons i=1, . . . , N, the following can be obtained: q=Φu with Φ=[Φ¹;Φ²; . . . ; Φ^{N}] and q=[q¹;q²; . . . ; q^{N}]. This system of linear equations can be solved for u, provided that the rank r(Φ) of matrix Φ satisfies r(Φ)=ΣₘΠₙ₌₁ⁿ^{ₘ}(2Lₙ+1). For example, a necessary condition for the latter can be that the total number of measurements generated by all N neurons is greater or equal to Πₙ₌₁ⁿ^{ₘ}(2Lₙ+1). Equivalently, the total number of spikes produced by all N neurons can be greater than Πₙ₌₁ⁿ^{ₘ}(2Lₙ+1)+N. Then u can be uniquely specified as the solution to a convex optimization problem, e.g., u=Φ⁺q. In one example, to find the sufficient condition, it can be noted that the m^{th} component v^{im} of the dendritic current vⁱ has a maximal bandwidth of Ωₙ_{ₘ} and only 2Lₙ_{ₘ}+1 measurements to specify it. Thus, in one example, each neuron can produce a maximum of only 2Lₙ_{ₘ}+1 informative measurements, or equivalently, 2Lₙ_{ₘ}+2 informative spikes on a time interval [0,Tₙ_{ₘ}]. It can follow that for each modality, at least the following can be required: Πₙ₌₁ⁿ^{ₘ}(2Lₙ+1)/(2Lₙ_{ₘ}+1) neurons if v≧(2Lₙ_{ₘ}+2) and at least |Πₙ₌₁ⁿ^{ₘ}(2Lₙ+1)/(v−1) neurons if v<(2Lₙ_{ₘ}+2). It should be understood that this exemplary channel identification method can also comprise determining a sampling coefficient using the one or more encoded signals, determining a measurement using one or more times of the one or more encoded signals, determining a reconstruction coefficient using the sampling coefficient and the measurement, and constructing the one or more output signals using the reconstruction coefficient and the measurement.

### EXAMPLE 5

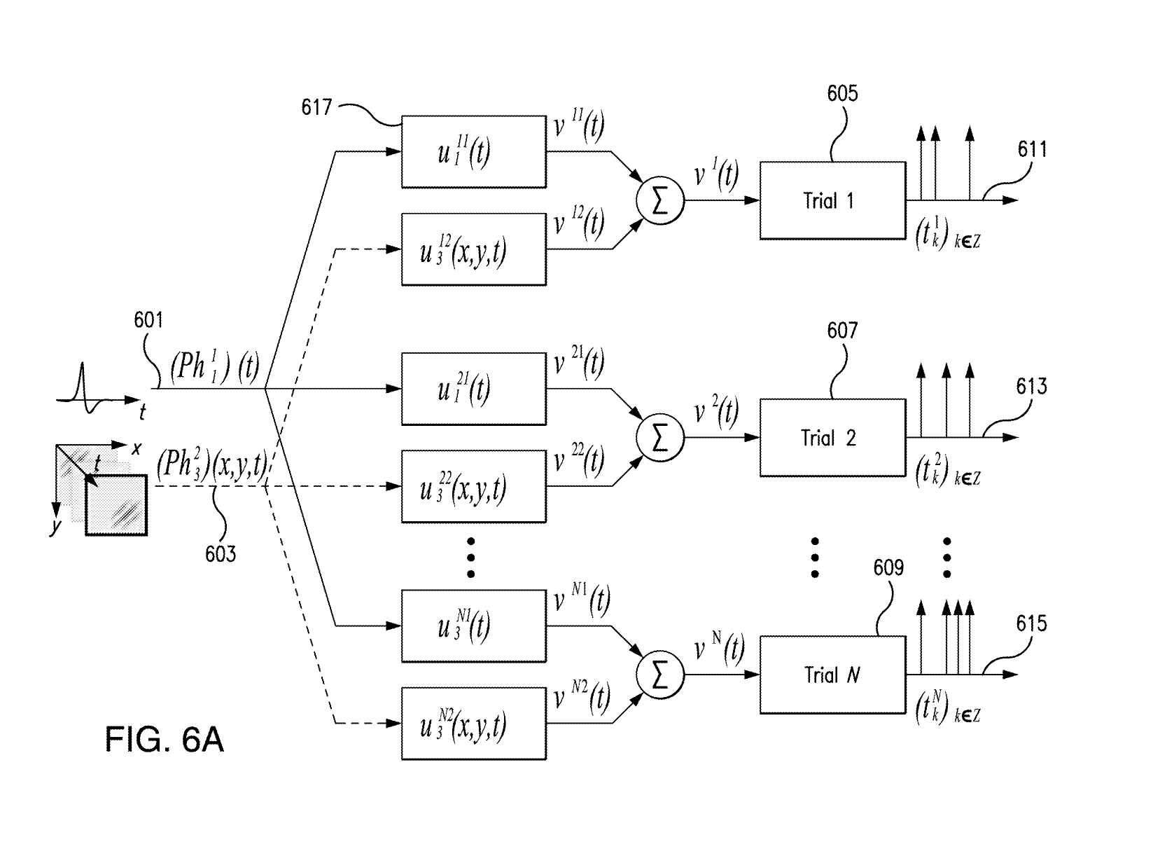

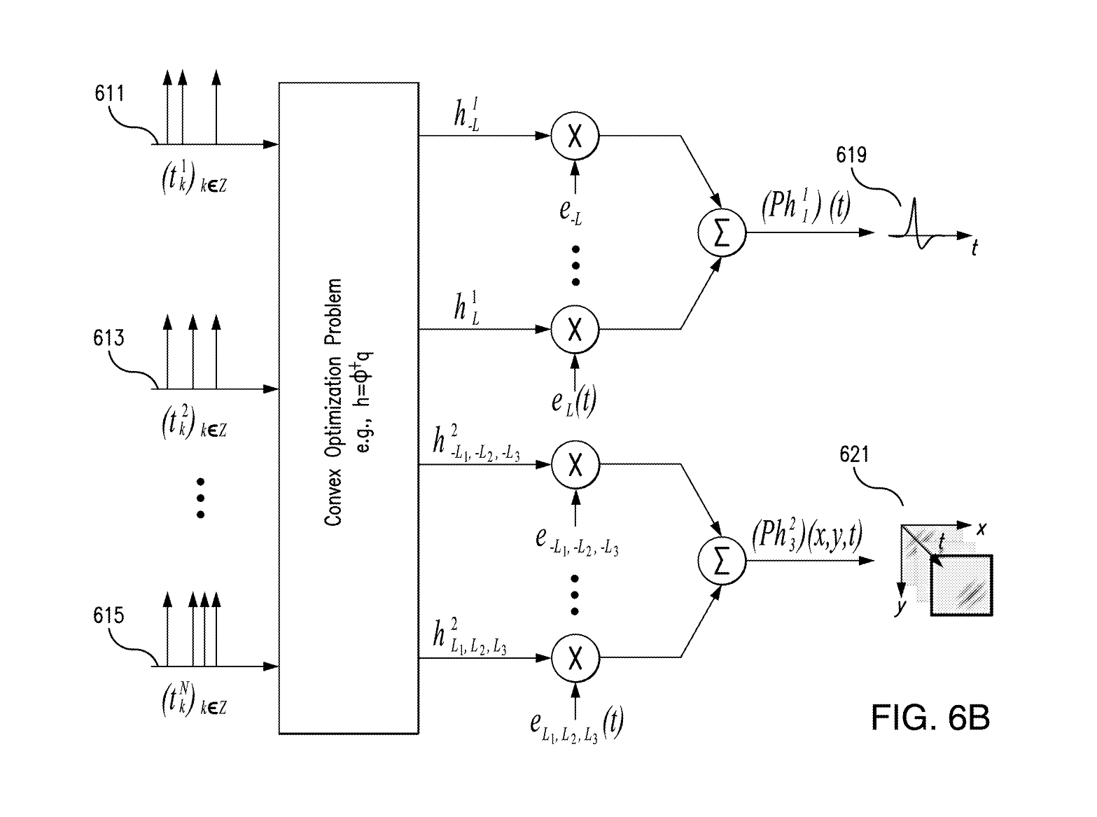

FIG. 6A and FIG. 6B illustrate an exemplary Multimodal CIM for identifying multisensory processing. FIG. 6A illustrates an exemplary Time encoding interpretation of the multimodal CIM. FIG. 6B illustrates an exemplary block diagram of the multimodal CIM. FIG. 6A further illustrates an exemplary neural encoding interpretation of the identification example for the grayscale video and mono audio TEM. FIG. 6B further illustrates an exemplary block diagram of the corresponding mCIM.

As further illustrated in FIG. 6A and FIG. 63, an exemplary nonlinear neural identification example can be described: given stimuli 617 uₙ_{ₘ}^{m}, m=1, . . . , M, at the input to a multisensory neuron i and spikes 611, 613, 615 at its output, the multisensory receptive field kernels 601, 603 hₙ_{ₘ}^{im}, m=1, . . . , M can be observed. In this example, it can be observed that the neural identification can be mathematically dual to the decoding problem described herein. Additionally or alternatively, it can be demonstrated that the neural identification example can be converted into a neural encoding example, where each spike train 611, 613, 615 (tₖⁱ)_{kεZ} produced during an experimental trial i, i=1, . . . , N, is interpreted to be generated by the i^{th} neuron in a population of N neurons 605, 607, 609. In one embodiment, identifying kernels for only one multisensory neuron can be considered and the superscript i in hₙ_{ₘ}^{im} can be dropped in this exemplary multisensory identification. In one example, identification for multiple neurons can be performed in a serial fashion. In another example, the natural notion of performing multiple experimental trials can be introduced and the same superscript i can be used to index stimuli uₙ_{ₘ}^{im} on different trials i=1, . . . , N.

With further reference to the exemplary multisensory neuron illustrated in FIG. 4A and FIG. 4B, since for every trial i, an input signal 401, 403 uₙ_{ₘ}^{im}, m=1, . . . , M, can be modeled as an element of some space Hₙ_{ₘ}, the following can be obtained: uₙ_{ₘ}^{im}(x₁, . . . , xₙ_{ₘ})= [symbol] uₙ_{ₘ}^{im}(•, . . . , •), Kₙ_{ₘ}(•, . . . , ;x₁, . . . , xₙ_{ₘ}) [symbol] by the reproducing property of the RK Kₙ_{ₘ}. Furthermore, it can follow that

$${\int }_{{D}_{{n}_{m}}} {h}_{{n}_{m}}^{m} ( {s}_{1} , … , {s}_{{n}_{m} - 1} , {s}_{{n}_{m}} ) {u}_{{n}_{m}}^{i m} ( {s}_{1} , … , {s}_{{n}_{m} - 1} , t - {s}_{{n}_{m}} ) d {s}_{1 } … d {s}_{{n}_{m} - 1} d {s}_{{n}_{m}} = {=}^{( a )} {\int }_{{D}_{{n}_{m}}} {u}_{{n}_{m}}^{i m} ( {s}_{1} , … , {s}_{{n}_{m} - 1} , {s}_{{n}_{m}} ) 〈 {h}_{{n}_{m}}^{m} ( \cdot , … , \cdot ) , {K}_{{n}_{m}} ( \cdot , … , \cdot ; {s}_{1} , {…s}_{{n}_{m} - 1} , t - {s}_{{n}_{m}} ) 〉 d {s}_{1} … d {s}_{{n}_{m}} {=}^{( b )} {\int }_{{D}_{{n}_{m}}} {u}_{{n}_{m}}^{i m} ( {s}_{1} , … , {s}_{{n}_{m} - 1} , {s}_{{n}_{m}} ) ( {Ph}_{{n}_{m}}^{m} ) ( {s}_{1} , … , {s}_{{n}_{m} - 1} , t - {s}_{{n}_{m}} ) d {s}_{1} … d {s}_{{n}_{m} - 1} d {s}_{{n}_{m}} , \qquad ( 13 )$$

where ^{(a)} can follow from the reproducing property and symmetry of Kₙ_{ₘ} and exemplary definition above, and ^{(b)} from the definition of Phₙ_{ₘ}^{m} in Equation (7). In this example, the t-transform of the mTEM in FIG. 4A and FIG. 4B can then be described as

Lₖⁱ¹[Phₙ_{₁}¹]+Lₖⁱ²[Phₙ_{₂}]+ . . . +Lₖ^{iM}[Phₙ_{_{M}}^{M}]=qₖⁱ, (14)

where Lₖ^{im}:Hₙ_{ₘ}→R, m=1, . . . , M, kεZ, are linear functionals that can be defined by

Lₖ^{im}[Phₙ_{ₘ}^{m}]∫ₜ_{ₖ}_{ⁱ}ⁱ^{ₖ₊₁}^{ⁱ}[∫_{D}_{ₘ}uₙ_{ₘ}^{im}(s₁, . . . , sₙ_{ₘ})(Phₙ_{ₘ}^{m})(s₁, . . . , t−sₙ_{ₘ})ds₁ . . . dsₙ_{ₘ}]dt. (15)

In this example, each inter-spike interval [tₖⁱ,tₖ₊₁ⁱ) produced by the IAF neuron can be a time measurement qₖⁱ of the (weighted) sum of all kernel projections Phₙ_{ₘ}^{m}, m=1, . . . , M

Furthermore, each projection Phₙ_{ₘ}^{m} can be determined by the corresponding stimuli uₙ_{ₘ}^{im}, i=1, . . . , N, employed during identification and can be substantially different from the underlying kernel hₙ_{ₘ}^{m}.

In one embodiment, the projections Phₙ_{ₘ}^{m}, m=1, . . . , M can be identified from the measurements (qₖⁱ)_{kεZ}. Additionally, any of the spaces Hₙ_{ₘ} can be chosen. As such, an arbitrarily-close identification of original kernels can be made provided that the bandwidth of the test signals is sufficiently large.

For purpose of illustration, an exemplary Multisensory Channel Identification Machine (mCIM) can be represented using the following equations and exemplary theorem:

In one example, a collection of N linearly independent stimuli 617 at the input to an mTEM circuit comprised of receptive fields with kernels 601, 603 hₙ_{ₘ}^{m}εHₙ_{ₘ}, m=1, . . . , M, in cascade with an ideal IAF neuron 605, 607, 609 can be represented by {uⁱ}ᵢ₌₁^{N}, uⁱ=[uₙ_{₁}ⁱ¹, . . . , uₙ_{_{M}}^{iM}]^{T}, uₙ_{ₘ}^{im}εHₙ_{ₘ}, m=1, . . . , M. Given the coefficients

$${u}_{{l}_{1} … {l}_{{n}_{m}}}^{im}$$

of stimuli uₙ_{ₘ}^{im}, i=1, . . . , N, m=1, . . . , M, the kernel projections Phₙ_{ₘ}^{m}, m=1, . . . , M, can be perfectly identified as

$$( {Ph}_{{n}_{m}}^{m} ) ( {x}_{1} , … , {x}_{{n}_{m}} ) = {\sum }_{{l}_{1} = - {L}_{1}}^{{L}_{1}} … {\sum }_{{l}_{{n}_{m}} = - {L}_{{n}_{m}}}^{{L}_{{n}_{m}}} {h}_{{l}_{1} … {l}_{{n}_{m}}}^{m} {e}_{{l}_{1} … {l}_{{n}_{m}}} ( {x}_{1} , … , {x}_{{n}_{m}} ) , where {h}_{{l}_{1} … {l}_{{n}_{m}}}^{m}$$

are elements of h=Φ⁺q, and Φ⁺ denotes the pseudo-inverse of Φ. Furthermore, Φ=[Φ¹;Φ²; . . . , Φ^{N}], q=[q¹;q²; . . . ; q^{N}] and [qⁱ]ₖ=qₖⁱ. Each matrix Φⁱ=[Φⁱ¹,Φⁱ², . . . , Φ^{im}], with

$${[ {Φ}^{im} ]}_{kl} = \{ \begin{matrix}{u}_{- {l}_{1} , - {l}_{2} , … , - {l}_{{n}_{m} - 1} , {l}_{{n}_{m}}}^{im} ( {t}_{k + 1}^{i} - {t}_{k}^{i} ) , & {l}_{{n}_{m}} = 0 \\ \frac{{u}_{- {l}_{1} , - {l}_{2} , … , - {l}_{{n}_{m} - 1} , {l}_{{n}_{m}}}^{im} {L}_{{n}_{m}} \sqrt{{T}_{{n}_{m}}} ( {e}_{{l}_{{n}_{m}}} ( {t}_{k + 1}^{i} ) - {e}_{{l}_{{n}_{m}}} ( {t}_{k}^{i} ) )}{j {l}_{{n}_{m}} {Ω}_{{n}_{m}}} , & {l}_{{n}_{m}} \neq 0\end{matrix} , \qquad ( 16 )$$

where l traverses all subscript combinations of l₁, l₂, . . . , lₙ_{ₘ}. In one example, a necessary condition for identification can be that the total number of spikes generated in response to all N trials is larger than Σₘ₌₁^{M}Πₙ₌₁ⁿ^{ₘ}(2Lₙ+1)+N. Additionally or alternatively, if the neuron produces v spikes on each trial, a sufficient condition can be that the number of trials

N≧|Σₘ₌₁^{M}Πₙ₌₁ⁿ^{ₘ}(2Lₙ+1)/min(v−1,2Lₙ_{ₘ}+1)|, (17)

For purposes of illustration, in an exemplary proof, the equivalent representation of the t-transform in Equation 8 and Equation 14 can imply that the decoding of the stimulus 617 uₙ_{ₘ}^{m}, as seen in an exemplary theorem described herein, and the identification of the filter projections 619, 621 Phₙ_{ₘ}^{m} can be dual examples. Therefore, the receptive field identification example can be equivalent to a neural encoding example: the projections 601, 603 Phₙ_{ₘ}^{m}, m=1, . . . , M, are encoded with an mTEM comprised of N neurons 605, 607, 609 and receptive fields 617 uₙ_{ₘ}^{im}, i=1, . . . , N, m=1, . . . , M. The exemplary method for finding the coefficients

$${h}_{{l}_{1} … {l}_{{n}_{m}}}^{m}$$

can be analogous to the one for

$${u}_{{l}_{1} … {l}_{{n}_{m}}}^{m}$$

in an exemplary theorem described herein.

### EXAMPLE 6

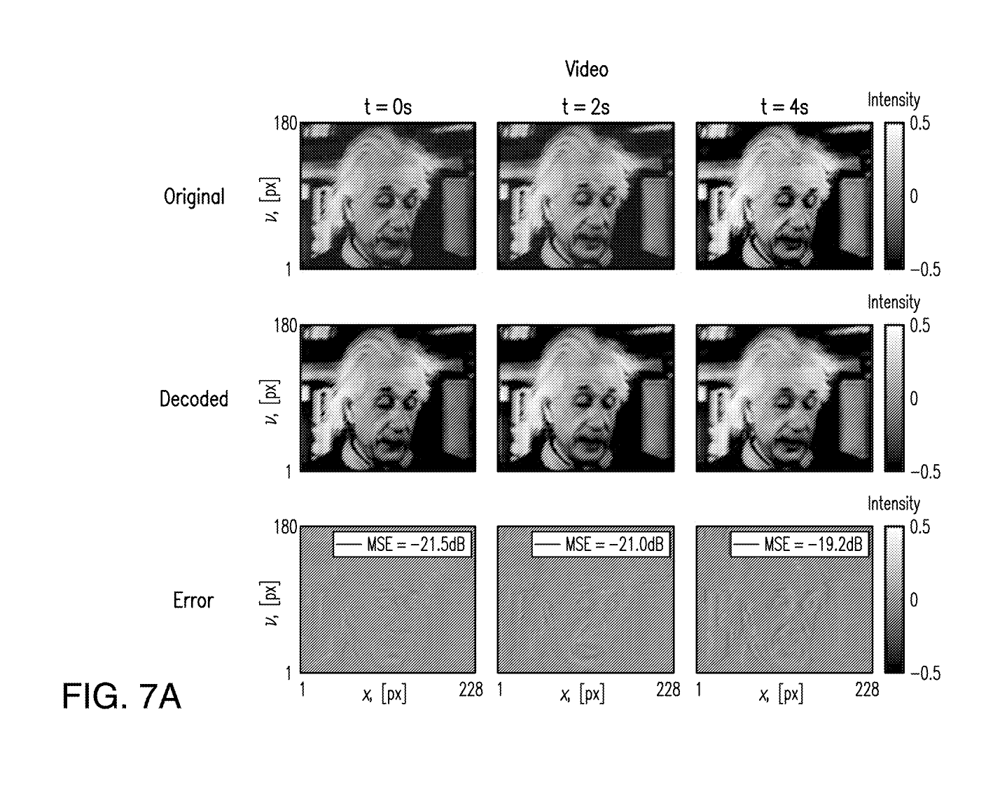

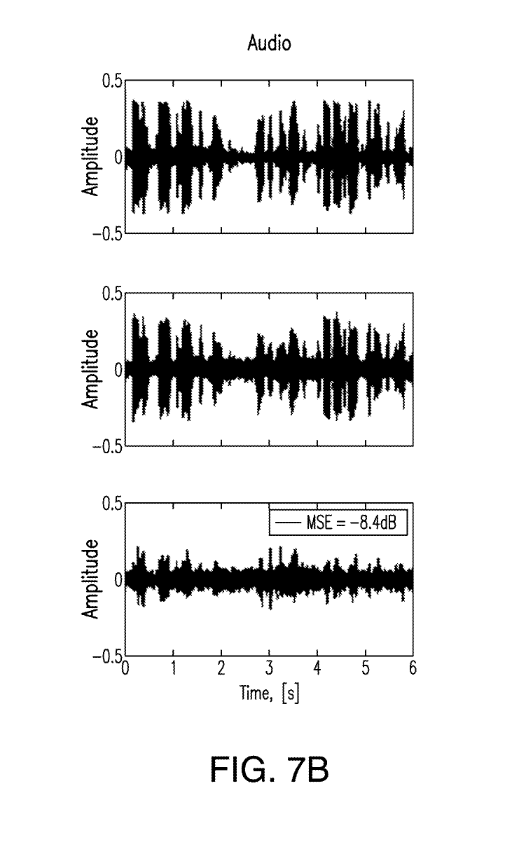

FIG. 7A and FIG. 7B illustrate exemplary multisensory decoding in accordance with the disclosed subject matter. FIG. 7A illustrates an exemplary Grayscale Video Recovery. The top row of FIG. 7A illustrates three exemplary frames of the original grayscale video u₃². The middle row of FIG. 7A illustrates exemplary corresponding three frames of the decoded video projection P₃u₃². The bottom row of FIG. 7A illustrates an exemplary error between three frames of the original and identified video, Ω₁=2π·2 rad/s, L₁=30, Ω₂=2π·36/19 rad/s, L₂=36, Ω₃=2π·4 rad/s, L₃=4. FIG. 7B illustrates an exemplary Mono Audio Recovery in accordance with the disclosed subject matter. The top row of FIG. 7B illustrates exemplary original mono audio signal u₁¹. The middle row of FIG. 7B illustrates exemplary decoded projection P₁u₁¹. The bottom row of FIG. 7B illustrates an exemplary error between the original and decoded audio. Ω=2π·4,000 rad/s, L=4,000.

For purposes of illustration, a mono audio and video TEM is described using temporal and spatiotemporal linear filters and a population of integrate-and-fire neurons, as further illustrated with reference to FIG. 4A and FIG. 4B. In this example, an analog audio signal u₁¹(t) and an analog video signal u₃²(x,y,t) can appear as inputs to temporal filters with kernels h₁ⁱ¹(t) and spatiotemporal filters with kernels h₃ⁱ²(x,y,t), i=1, . . . , N. Additionally or alternatively, each temporal and spatiotemporal filter can be realized in a number of ways, e.g., using gammatone and Gabor filter banks. Furthermore, it can be assumed that the number of temporal and spatiotemporal filters in FIG. 4A and FIG. 4B is the same. It should be understood that the number of components can be different and can be determined by the bandwidth of input stimuli Ω, or equivalently the order L, and the number of spikes produced, as seen in the exemplary theorems described herein.

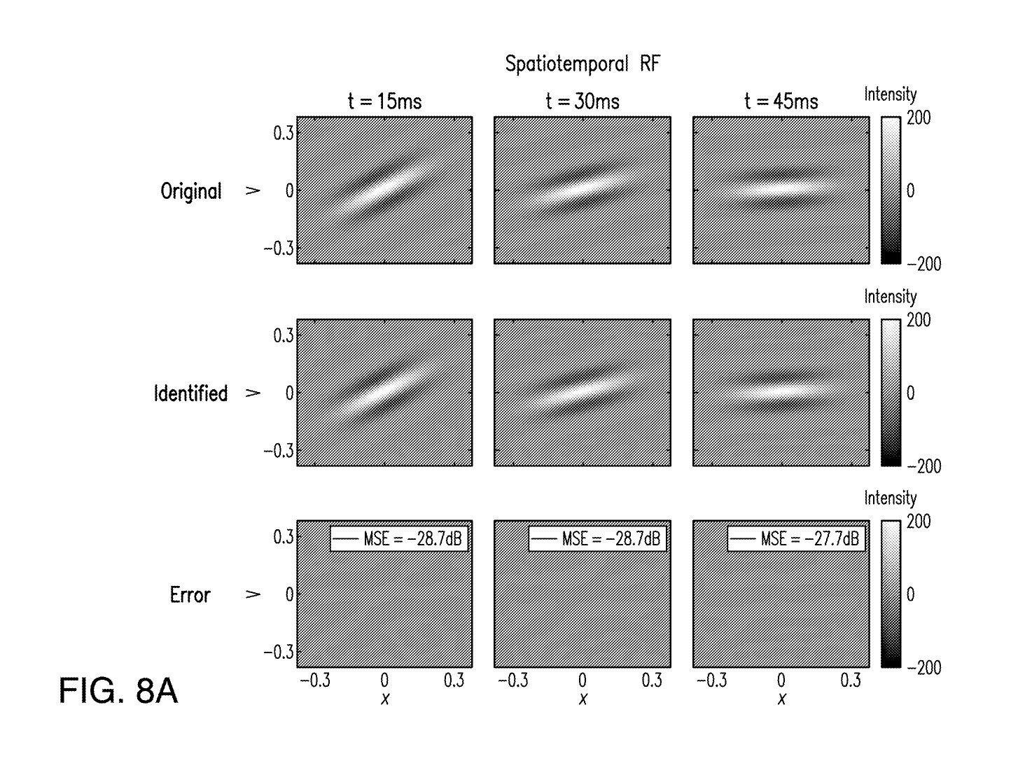

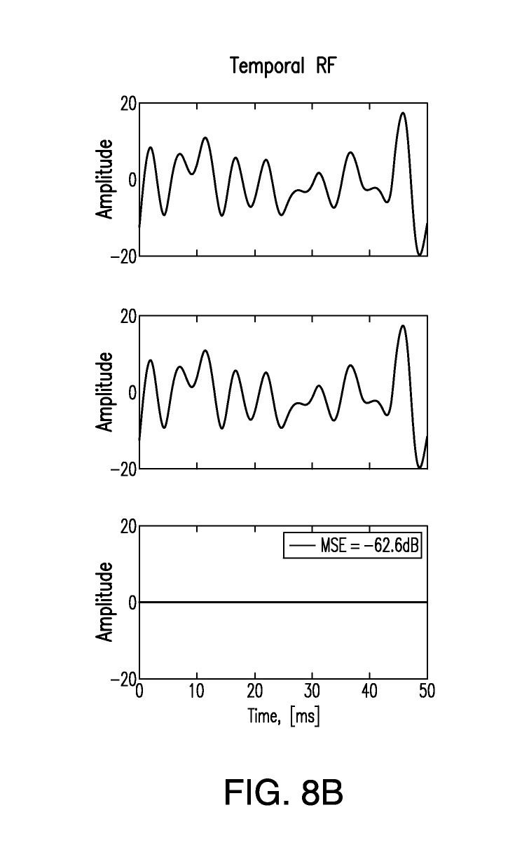

FIG. 8A and FIG. 8B illustrate exemplary Multisensory identification in accordance with the disclosed subject matter. FIG. 8A and FIG. 8B further illustrates an exemplary performance of the mCIM method disclosed herein. FIG. 8A and FIG. 8B illustrate an exemplary original spatio-temporal and temporal receptive fields in the top row and recovered spatio-temporal and temporal receptive fields in the middle row and the error between the original spatio-temporal and temporal receptive fields and the recovered spatio-temporal and temporal receptive fields.

The top row of FIG. 8A illustrates three exemplary frames of the original spatiotemporal kernel h₃²(x,y,t). As further illustrated in FIG. 8A, h₃² can be a spatial Gabor function rotating clockwise in space as a function of time. The middle row of FIG. 8A illustrates exemplary corresponding three frames of the identified kernel Ph₃²*+(x,y,t). The bottom row of FIG. 8A illustrates an exemplary error between three frames of the original and identified kernel. Ω₁=2π·12 rad/s, L₁=9, Ω₂2π·12 rad/s, L₂=9, Ω₃=2π·100 rad/s, L₃=5. FIG. 8B illustrates an exemplary identification of the temporal RF. The top row of FIG. 8B illustrates an exemplary original temporal kernel h₁¹(t). The middle row of FIG. 8B illustrates an exemplary identified projection Ph₁¹*(t). The bottom row of FIG. 8B illustrates an exemplary error between h₁¹ and Ph₁¹*. Ω=2π·200 rad/s, L=10.

In this example, for each neuron i, i=1, . . . , N, the filter outputs vⁱ¹ and vⁱ², can be summed to form the aggregate dendritic current vⁱ, which can be encoded into a sequence of spike times (tₖⁱ)_{kεZ} by the i^{th} integrate-and-fire neuron. Thus each spike train (tₖ)_{kεZ} can carry information about two stimuli of completely different modalities, for example, audio and video. In another example, the entire collection of spike trains {tₖⁱ}ᵢ₌₁^{N}, kεZ, can provide a faithful representation of both signals.

For purposes of illustration, an exemplary performance of the disclosed herein is illustrated. In this example, a multisensory TEM with each neuron having a non-separable spatiotemporal receptive field for video stimuli and a temporal receptive field for audio stimuli can be used. In this example, spatiotemporal receptive fields can be chosen randomly and have a bandwidth of 4 Hz in temporal direction t and 2 Hz in each spatial direction x and y. Similarly, temporal receptive fields can be chosen randomly from functions bandlimited to 4 kHz. As such, in this example, two distinct stimuli having different dimensions, for example, three dimensions for a video signal and one dimension for an audio signal. Furthermore, the dynamics, for example 2-4 cycles compared to 4,000 cycles in each direction, can be multiplexed at the level of every spiking neuron and encoded into an unlabeled set of spikes. In this example, the mTEM can produce a total of 360,000 spikes in response to a 6-second-long grayscale video and mono audio of Albert Einstein explaining the mass-energy equivalence formula E=mc²: “ . . . [a] very small amount of mass can be converted into a very large amount of energy.” Additionally or alternatively, a multi sensory TDM can then be used to reconstruct the video and audio stimuli from the produced set of spikes.

In this example, it can be noted that the neuron blocks illustrated in FIG. 4A and FIG. 4B can be replaced by trial blocks. Furthermore, the stimuli can appear as kernels describing the filters and the inputs to the circuit are kernel projections Phₙ_{ₘ}^{m}, m=1, . . . , M. As such, identification of a single neuron can be converted into a population encoding example, where the artificially constructed population of N neurons can be associated with the N spike trains generated in response to N experimental trials.

### EXAMPLE 7

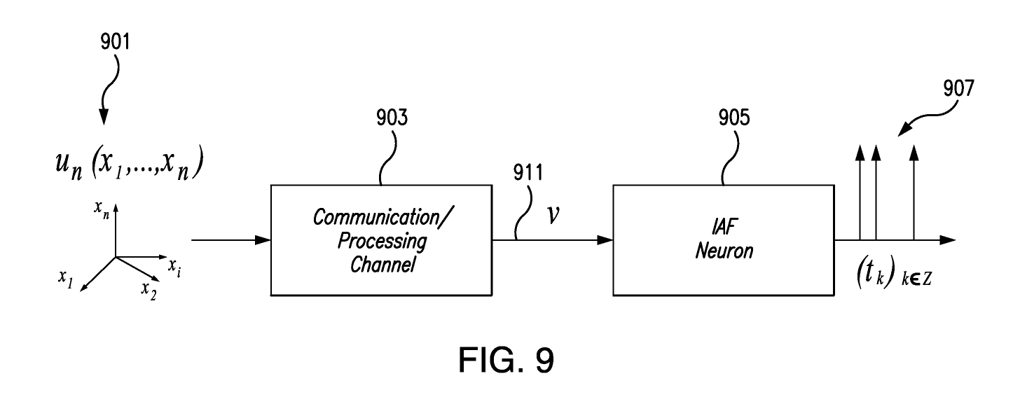

FIG. 9 illustrates another exemplary multidimensional TEM system in accordance with the disclosed subject matter is described herein. As further illustrated in FIG. 9, in this example, the multidimensional TEM system can include a filter which appears in cascade with IAF neurons. FIG. 9 further illustrates a single-input single-output (SISO) multidimensional TEM and its input-output behavior.

For purposes of illustration, it can be assumed that memory effects in the neural circuit can arise in the temporal dimension t of the stimulus and interactions in other dimensions can be multiplicative in their nature. As such, the output 911 v of the multidimensional receptive field can be described by a convolution in the temporal dimension and integration in all other dimensions, such as:

v(t)=∫_{D}_{ₙ}hₙ(x₁, . . . , xₙ₋₁,s)uₙ(x₁, . . . , xₙ₋₁,t−s)dx₁ . . . dxₙ₋₁ds. (18)

The temporal signal 911 v(t) can represent the total dendritic current flowing into the spike initiation zone, where it is encoded into spikes 907 by a point neuron model 905, such as the IAF neuron 905 illustrated in FIG. 9. In one example, the IAF neuron 905 illustrated in FIG. 9 can be leaky. Furthermore, the mapping of the multidimensional stimulus u into a temporal sequence (tₖ)_{kεZ} can be described by the set of equations

$${\int }_{{t}_{k}}^{{t}_{k + 1}} v ( t ) exp ( \frac{t - {t}_{k + 1}}{RC} ) d t = {q}_{k} , k ∈ Z , \qquad ( 19 )$$

Which can also be known as the t-transform, where

$${q}_{k} = C δ + bRC [ exp ( \frac{{t}_{k} - {t}_{k + 1}}{RC} ) - 1 ] . \qquad ( 20 )$$

For purposes of illustration, assuming the stimulus 901 uₙ(x₁, . . . , xₙ₋₁,t)εHₙ and using the kernel representation, the following equation can be described:

∫_{D}_{ₙ}hₙ(x₁, . . . , xₙ−1,s)uₙ(x₁, . . . , xₙ−1,t−s)dx₁ . . . dxₙ₋₁ds=

∫_{D}_{ₙ}hₙ(x₁, . . . , xₙ−1,s)[∫_{D}_{ₙ}u_{n(y)} K̅ₙ̅(̅y̅|̅x̅₁̅,̅ .̅ .̅ .̅ ,̅ x̅_̅{̅n̅-̅1̅,̅t̅-̅s̅)̅}̅_{dy}]dx₁ . . . dxₙ₋₁ds=

uₙ(y)└∫_{D}_{ₙ}hₙ(x₁, . . . , xₙ₋₁,s)K̅ₙ̅(̅x̅₁̅,̅ .̅ .̅ .̅ ,̅ x̅ₙ̅₋̅₁̅,̅s̅ᵢ̅y̅₁̅ .̅ .̅ .̅ y̅ₙ̅₋̅₁̅,̅t̅−̅y̅ₙ̅)̅dx₁ . . . dxₙ₋₁ds┘dy=∫_{D}_{ₙ}

∫_{D}_{ₙ}uₙ(y)(Phₙ)(y₁, . . . , t−yₙ)dy, (21)

where y=(y₁, . . . , yₙ) and dy=dy₁dy₂ . . . dyₙ.

Additionally, the linear functional can be defined as Lₖ:Hₙ→R

$${ℒ}_{k} ( 𝒫 {h}_{n} ) {=}^{Δ} {\int }_{{t}_{k}}^{{t}_{k + 1}} [ {\int }_{{𝔻}_{n}}^{ } {u}_{n} ( {x}_{1} , … , {x}_{n - 1} , s ) ( 𝒫 {h}_{n} ) ( {x}_{1} , … , {x}_{n - 1} , t - s ) d {x}_{1 } … d {x}_{n - 1} d s ] exp ( \frac{t - {t}_{k + 1}}{RC} ) d t = {q}_{k} \qquad ( 22 )$$

By the Riesz representation theorem there can be a function φₖεHₙ such that

Lₖ(Phₙ)= [symbol] Phₙ,φₖ [symbol] . (23)

As such, the following can equation can be derived:

An exemplary SISO multidimensional TEM with a multidimensional input 901 uₙ=uₙ(x₁, . . . , xₙ₋₁,t) processed by a receptive field 903 with kernel k=hₙ=hₙ(x₁, . . . , xₙ₋₁,t) and encoded into a sequence of spike times 907 (tₖ)_{kεZ} by the leaky integrate-and-fire neuron 905 with threshold δ, bias b and membrane time constant RC can provide a measurement of the projection of the kernel onto the input stimulus space. As such, the t-transform can be described as an inner product

[symbol]

Phₙ,φₖ [symbol] =qₖ (24)

for every inter-spike interval [tₖ, tₖ₊₁], kεZ·

In this example, information about the receptive field can be encoded in the form of quantal measurements qₖ. These measurements can be readily computed from the spike times (tₖ)_{kεZ}. Furthermore, the information about the receptive field can be partial and can depend on the stimulus space Hₙ used in identification. Specifically, qₖ's can be measurements not of the original kernel hₙ but of its projection Phₙ onto the space Hₙ.

### EXAMPLE 8

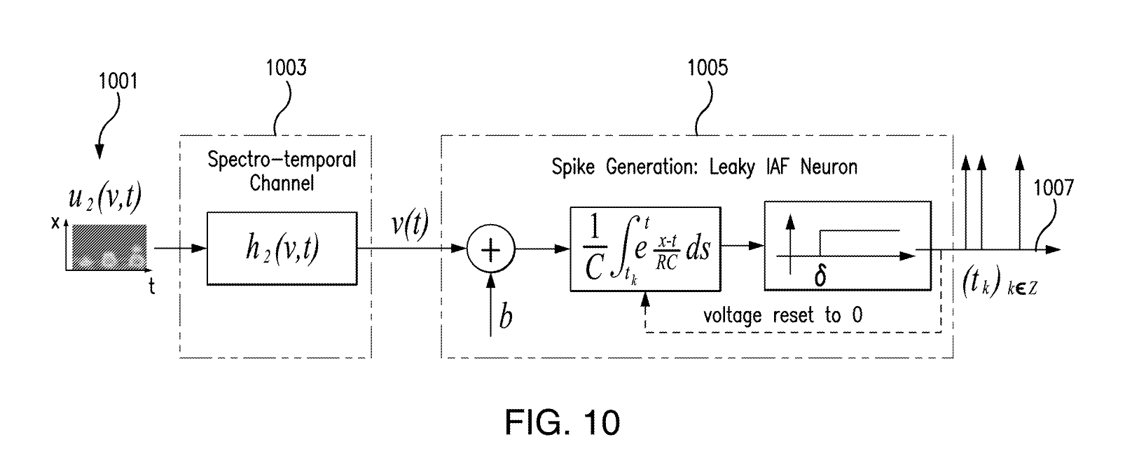

FIG. 10 illustrates another exemplary TEM in accordance with the disclosed subject matter. FIG. 10 further illustrates an exemplary Block diagram of a circuit with a spectrotemporal communication channel. FIG. 10 further illustrates an exemplary SISO Spectrotemporal TEM. As illustrated in FIG. 10, the signal 1001 u₂(v, (v,t)εD₂=[0,T₁]×[0,T₂], can be an input to a communication or processing channel 1003 with kernel h₂(v,t) In one embodiment, the signal 1001 u₂(v,t) can represent the time-varying amplitude of a sound in a frequency band centered around v and h₂(v,t) the spectrotemporal receptive field (STRF). Furthermore, the output v of the kernel 1003 can be encoded into a sequence of spike times 1007 (tₖ)_{kεZ} by, for example, the leaky integrate-and-fire neuron 1005 with a threshold δ, bias b and membrane time constant RC. A spectrotemporal TEM can be used to model the processing or transmission of, e.g., auditory stimuli characterized by a frequency spectrum varying in time.

In one example, the operation of such a TEM can be described by the t-transform

$${\int }_{{t}_{k}}^{{t}_{k + 1}} [ {\int }_{{D}_{2}}^{ } {h}_{2} ( v , s ) {u}_{2} ( v , t - s ) d v d s ] exp ( \frac{t - {t}_{k + 1}}{RC} ) d t = {q}_{k} , \qquad ( 25 )$$

with qₖ given by Equation 20 for all kεZ.

For purposes of illustration, assuming the spectrotemporal stimulus u₂(v,t)εH₂, Equation 25

can be written as

$${q}_{k} {\int }_{{t}_{k}}^{{t}_{k + 1}} [ {\int }_{{𝔻}_{2}}^{ } {u}_{2} ( v , s ) {Ph}_{2} ( v , t - s ) d v d s ] exp ( \frac{t - {t}_{k + 1}}{RC} ) d t {=}^{Δ} {ℒ}_{k} ( {Ph}_{2} ) \qquad ( 26 )$$

where Lₖ:H₂→R is a linear functional. By the Riesz representation theorem, there can exist a function φₖεH₂ such that

Lₖ(Ph₂)= [symbol] Ph₂,φₖ [symbol] . (27)

### EXAMPLE 9

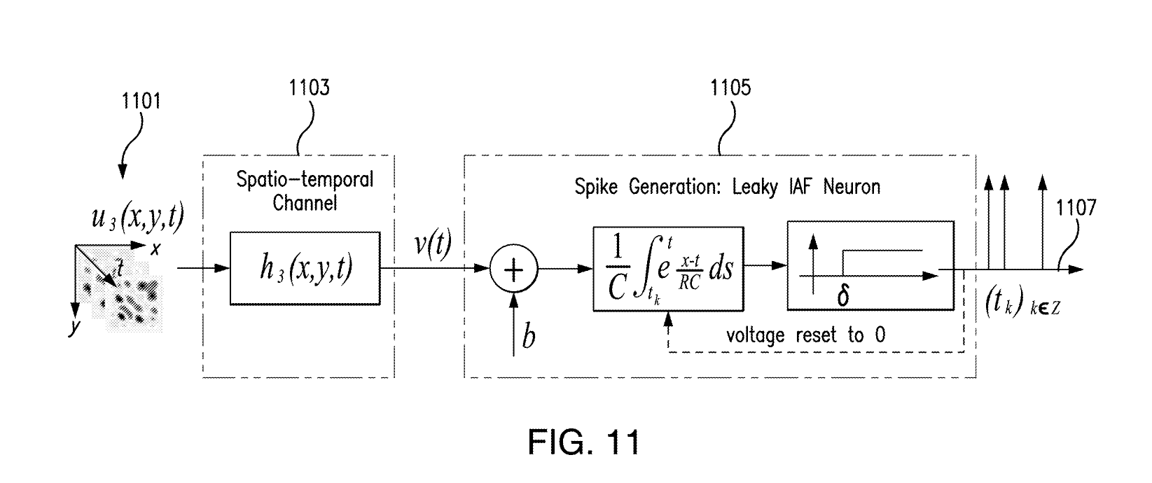

FIG. 11 illustrates another exemplary TEM in accordance with the disclosed subject matter. FIG. 11 further illustrates an exemplary block diagram of a circuit with a spatiotemporal communication channel. FIG. 11 further illustrates an exemplary SISO Spatiotemporal TEM. As further illustrated in FIG. 11, a video signal 1101 u₃(x,y,t), (x,y,t)εD₃=[0,T₁]×[0,T₂]×[0,T₃], can appear as an input to a communication or processing channel described by a filter with kernel 1103 h₃(x,y,t). The output v of the kernel can be encoded into a sequence of spike times 1107 (tₖ)_{kεZ} by the leaky integrate-and-fire neuron 1105 with a threshold δ, bias b and membrane time constant RC.

For purposes of illustration, a spatiotemporal TEM can be used to model the processing or transmission of, for example, video stimuli 1101 characterized by a spatial component varying in time. The t-transform of such a TEM can be described by:

$${\int }_{{t}_{k}}^{{t}_{k + 1}} [ {\int }_{{D}_{3}}^{ } {h}_{3} ( x , y , s ) {u}_{3} ( x , y , t - s ) d x d y d s ] exp ( \frac{t - {t}_{k + 1}}{RC} ) d t = {q}_{k} , \qquad ( 28 )$$

with qₖ described by Equation 20 for all kεZ.

For purposes of illustration, assuming the video stimulus u₃(x,y,t)εH₃, Equation 28 can be written as

$${q}_{k} {\int }_{{t}_{k}}^{{t}_{k + 1}} [ {\int }_{{𝔻}_{3}}^{ } {u}_{3} ( x , y , s ) {Ph}_{3} ( x , y , t - s ) d x d y d s ] exp ( \frac{t - {t}_{k + 1}}{RC} ) d t {=}^{Δ} {ℒ}_{k} ( {Ph}_{3} ) \qquad ( 29 )$$

where Lₖ:H₃→R is a linear functional. By the Riesz representation theorem, there can be a function φₖεH₃ such that

Lₖ(Ph₃)= [symbol] Ph₃,φₖ [symbol] . (30)

### EXAMPLE 10

For purposes of illustration, another exemplary TEM is described herein. In this example, a SISO Spatial TEM is described, which is a special case of the SISO Spatiotemporal TEM. In this example, the communication or processing channel can affect the spatial component of the spatiotemporal input signal. As such, the output of the receptive field can be described by:

v(t)=∫_{D}_{₂}h₂(x,y)u₃(x,y,t)dxdy. (31)

In one example, if only the spatial component of the input is processed, a simpler stimulus that does not vary in time can be presented when identifying this system. For example, such a stimulus can be a static image u₂(x,y). As such,

$${q}_{k} {\int }_{{t}_{k}}^{{t}_{k + 1}} [ {\int }_{{𝔻}_{2}}^{ } {u}_{2} ( x , y ) {Ph}_{2} ( x , y ) d v d y ] exp ( \frac{t - {t}_{k + 1}}{RC} ) d t {=}^{Δ} {ℒ}_{k} ( {Ph}_{2} ) \qquad ( 32 )$$

where Lₖ:H₂→R is a functional. As described herein, by the Riesz representation theorem, there can be a function φₖεH₂ such that

Lₖ(Ph₂)= [symbol] Ph₂,φₖ [symbol] . (33)

### EXAMPLE 11

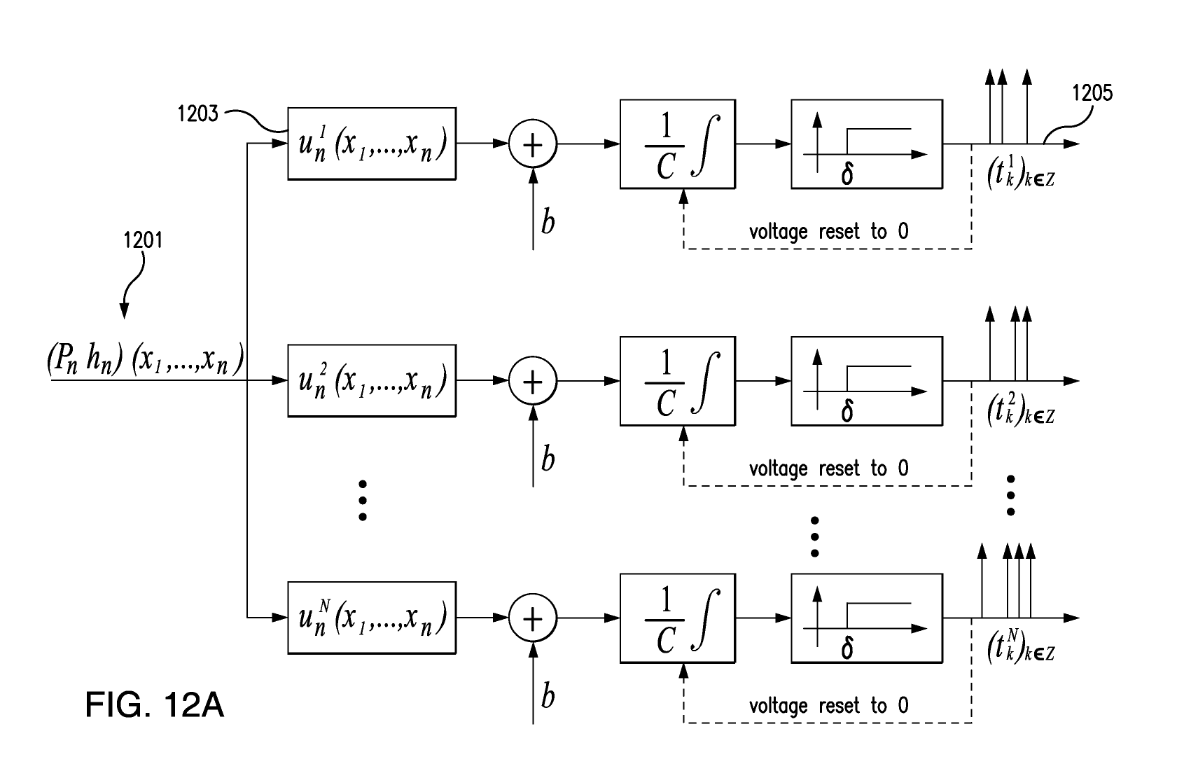

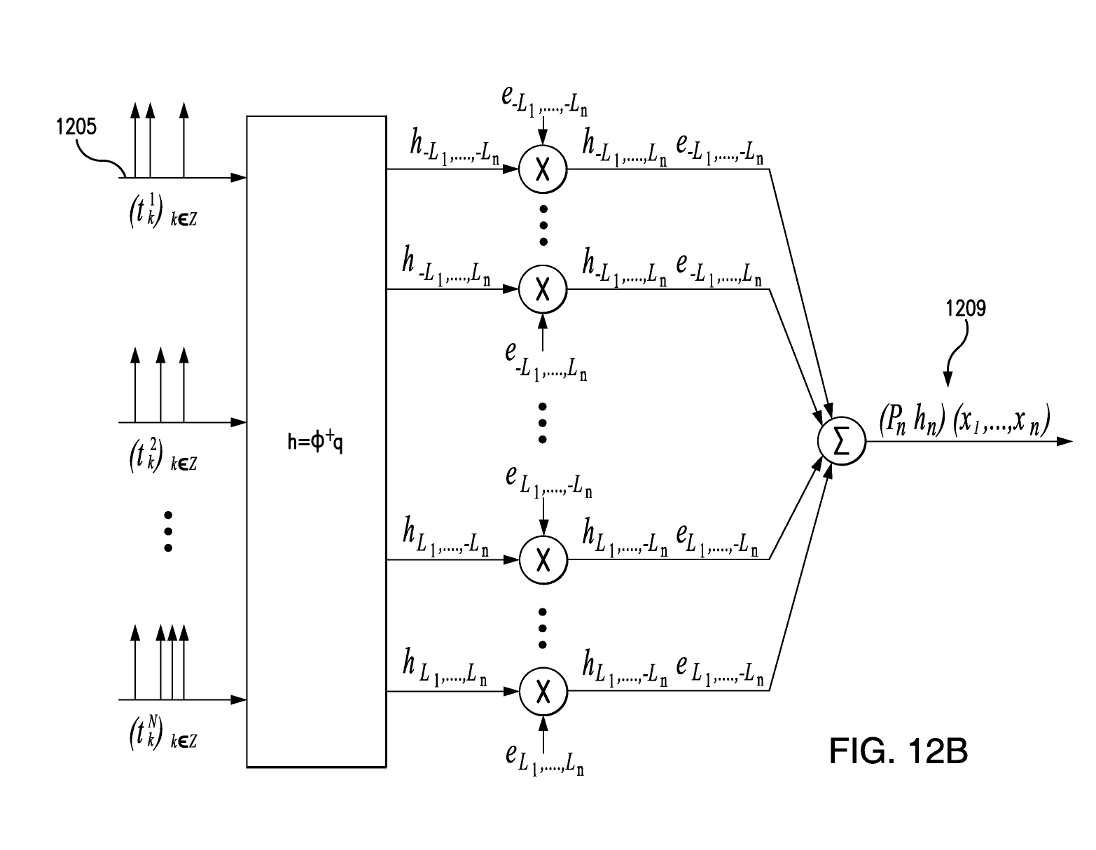

FIG. 12A and FIG. 12B illustrate another exemplary CIM in accordance with the disclosed subject matter. FIG. 12A and FIG. 12B further illustrates an exemplary feedforward Multidimensional SISO CIM. FIG. 12A further illustrates an exemplary time encoding interpretation of the multidimensional channel identification problem.

As described herein, there can be a relationship between the identification of a receptive field example and an irregular sampling example. For example, a projection 1201 Phₙ of the multidimensional receptive field hₙ can be embedded in the output spike sequence 1205 of the neuron as samples, or quantal measurements, qₖ of Phₙ. In this example, a method to reconstruct Phₙ from these measurements is described in accordance with the disclosed subject matter.

For purposes of illustration, let {uₙⁱ|uₙⁱεHₙ}ᵢ₌₁^{N} be a collection of N linearly independent stimuli 1203 at the input to a exemplary TEM that includes a filter in cascade with a leaky IAF neuron circuit with a multidimensional receptive field hₙεHₙ. In this example, if the number of signals N≧Πₚ₌₁ⁿ⁻¹(2Lₚ+1) and the total number of spikes produced in response to all stimuli is greater than Πₚ₌₁ⁿ(2Lₚ+1)+N then the filter projection 1201, 1209 Phₙ can be identified from a collection of input-output pairs {(uₙⁱ,Tⁱ)}ᵢ₌₁^{N} as:

$$( {Ph}_{n} ) ( {x}_{1} , … , {x}_{n - 1} , t ) = {\sum }_{\vert {l}_{1} \vert \leq {L}_{1}} … {\sum }_{\vert {l}_{n} \vert \leq {L}_{n}} {h}_{{l}_{1} {l}_{2} … {l}_{n}} {e}_{{l}_{1} {l}_{2} … {l}_{n}} ( {x}_{1} , … , {x}_{n - 1} , t ) , \qquad ( 34 )$$

where h=Φ⁺q. Here [h]ₗ=hₗ_{₁}_{, . . . , l}_{ₙ}, Φ=[Φ¹;Φ²; . . . ; Φ^{N}] and the elements of each matrix Φⁱ are given by

$$[ {Φ}^{i} ] kl = \frac{{RCL}_{n} \sqrt{{T}_{n}} {u}^{i} - {l}_{1} , … , - {l}_{n - 1} , {l}_{n}}{j {l}_{n} {Ω}_{n} RC + {L}_{n}} [ e {l}_{n} ( {t}_{k + 1}^{i} ) - e {l}_{n} ( {t}_{k}^{i} ) exp ( \frac{{t}_{k}^{i} - {t}_{k + 1}^{i}}{RC} ) ] \qquad ( 35 )$$

with the column index l traversing all subscript combinations of l₁, l₂, . . . , l_{N} for all kεZ, i=1, 2, . . . , N. Furthermore, q=[q¹;q²; . . . ; q^{N}], [qⁱ]ₖ=qₖⁱ and

$${q}_{k}^{l} = C δ + bRC [ exp ( \frac{{t}_{k}^{i} - {t}_{k + 1}^{i}}{RC} ) - 1 ] \qquad ( 36 )$$

for kεZ, i=1, . . . , N.

In an exemplary proof, the representation for Equation 23 for stimuli uₙⁱ can take the form

Lₖⁱ(Phₙ)= [symbol] Phₙ,φₖⁱ [symbol] =qₖⁱ (37)

with φₖⁱεHₙ. Since PhₙεHₙ and φₖⁱεHₙ,

$$\begin{matrix}( {Ph}_{n} ) ( {x}_{1} , … , {x}_{n - 1} , t ) = {\sum }_{\vert {l}_{1} \vert \leq {L}_{1}} … {\sum }_{\vert {l}_{n} \vert \leq {L}_{n}} {h}_{{l}_{1} … {l}_{n}} {e}_{{l}_{1} … {l}_{n}} ( {x}_{1} , … , {x}_{n - 1} , t ) , \\ and & ( 38 ) \\ {φ}_{k}^{i} ( {x}_{1} , … , {x}_{n - 1} , t ) = {\sum }_{\vert {l}_{1} \vert \leq {L}_{1}} … {\sum }_{\vert {l}_{n} \vert \leq {L}_{n}} {φ}_{{l}_{1} … {l}_{n} k}^{i} {e}_{{l}_{1} … {l}_{n}} ( {x}_{1} , … , {x}_{n - 1} , t ) , \\ and , therefore , & ( 39 ) \\ {q}_{k}^{i} = {\sum }_{\vert {l}_{1} \vert \leq {L}_{1}} … {\sum }_{\vert {l}_{n} \vert \leq {L}_{n}} {h}_{{l}_{1} … {l}_{n}} \overline{{φ}_{{l}_{1} … {l}_{n} k}^{i}} . & ( 40 )\end{matrix}$$

Furthermore, in matrix form, qⁱ=Φⁱh, with [qⁱ]ₖ=qₖⁱ can be obtained, where the elements [Φⁱ]ₖₗ=φ̅ₗ̅_̅{̅₁̅}̅_̅{̅.̅ .̅ .̅ l̅}̅_̅{̅ₙ̅}̅ₖ̅ⁱ̅, with the column index l traversing all subscript combinations of l₁, l₂, . . . , lₙ and [h]ₗ=hₗ_{₁}_{, . . . , l}_{ₙ}. Additionally or alternatively, repeating for all signals i=1, . . . , N, the following can be obtained: q=Φh with q=[q¹;q²; . . . ; q^{N}] and Φ=[Φ¹;Φ²; . . . ; Φ^{N}]. Furthermore, in one example, this system of linear equations can be solved for h, provided that the rank r(Φ) of the matrix Φ satisfies r(Φ)=Πₚ₌₁ⁿ(2Lₚ+1). For purposes of illustration, a necessary condition for the latter can be that the total number of spikes generated by all N neurons is greater or equal to Πₚ₌₁ⁿ(2Lₚ+1)+N. Then h=Φ⁺q, where Φ⁺ denotes a pseudo-inverse of Φ. Furthermore, to find the coefficients φ̅ₗ̅_̅{̅₁̅}̅_̅{̅.̅ .̅ .̅ l̅}̅_̅{̅ₙ̅}̅ₖ̅ⁱ̅,

$$\overline{{ϕ}_{{l}_{1 } … {l}_{n} k}^{l}} = {L}_{k}^{i} ( {e}_{{l}_{1} … {l}_{n}} ) = {\int }_{{t}_{k}^{i}}^{{t}_{k}^{i} + 1} ⌊ {\int }_{{D}_{n}}^{ } {e}_{{l}_{1 … } {l}_{n}} ( {x}_{1} , … , {x}_{n - 1} , t - s ) {u}_{n}^{i} ( {x}_{1 , … } {x}_{n - 1} , s ) d {x}_{1 … } d {x}_{n - 1} d s ⌋ exp ( \frac{t - {t}_{k + 1}^{i}}{RC} ) d t = {\int }_{{t}_{k}^{i}}^{{t}_{k + 1}^{i}} [ {\int }_{{D}_{n}}^{ } {e}_{{l}_{1 … } {l}_{n}} ( {x}_{1} , … , x n - 1 , t - s ) {\sum }_{\vert {l}_{1} \vert \leq {L}_{1}} … {\sum }_{\vert {l}_{n} \vert \leq {L}_{n}} {u}_{{l}_{1} …}^{i} {l}_{n } {e}_{{l}_{1 } … } {l}_{n } ( {x}_{1} , … , {x}_{n - 1} , s ) d {x}_{1 } … d {x}_{n - 1} d s ] \times exp ( \frac{t - {t}_{k + 1}^{i}}{RC} ) d t = \sqrt{{T}_{n}} {\int }_{{t}_{k}^{i}}^{{t}_{k + 1}^{i}} {u}_{- {l}_{1 , … ,} - {1}_{n - 1} {l}_{n}}^{i} {e}_{{l}_{n}} ( t ) exp ( \frac{t - {t}_{k + 1}^{i}}{RC} ) d t = \frac{{RCL}_{n} \sqrt{{T}_{n}} {u}_{- {l}_{1 … ,} {1}_{n - 1} {l}_{n}}^{i}}{j {l}_{n} {Ω}_{n} RC + {L}_{n}} [ {e}_{{l}_{n}} ( {t}_{k + 1}^{i} ) - {e}_{{l}_{n}} ( {t}_{k}^{i} ) exp ( \frac{{t}_{k}^{i} - {t}_{k + 1}^{i}}{RC} ) ] \qquad ( 41 )$$

In one example, the dendritic current v can have a maximum bandwidth of Ωᵢ, where 2Lᵢ+1 measurements can be required to specify it. As such, in response to each stimulus uₙⁱ, the neuron can produce a maximum of only 2Lᵢ+1 informative measurements, or equivalently, 2Lᵢ+2 informative spikes on the interval [0,Tᵢ]. As such, if the neuron generates v≧2Lᵢ+2 spikes, the minimum number of signals can be demonstrated by N=Πₚ₌₁ⁿ⁻¹(2Lₚ+1)(2Lₜ+1)/(2Lₜ+1)=Πₚ₌₁ⁿ⁻¹(2Lₚ+1). Similarly, if the neuron generates v<2Lₜ+2 spikes for each signal, then the minimum number of signals can be N=┌Σₚ₌₁ⁿ(2Lₚ+1)/(v−1)┐.

In one example, identification of the filter hₙ can be reduced to the encoding of the projection Phₙ with a TEM, for example a SIMO TEM whose receptive fields are uₙⁱ, i=1, . . . , N.

### EXAMPLE 12

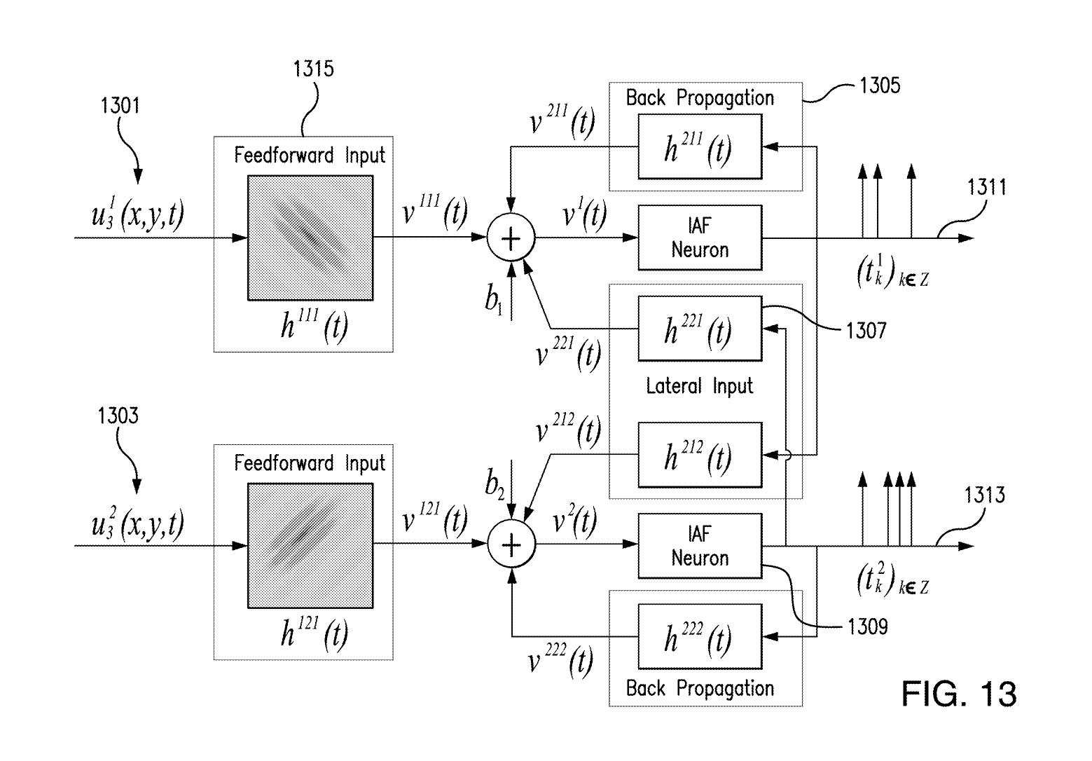

FIG. 13 illustrates another exemplary TEM in accordance with the disclosed subject matter. FIG. 13 further illustrates an exemplary MIMO Multidimensional TEM with Lateral Connectivity and Feedback.

As further illustrated in FIG. 13, for purposes of illustration, another exemplary spiking neural circuit, such as, a complex spiking neural circuits can be considered in which every neuron can receive not only feedforward inputs 1315, but also lateral inputs 1307 from neurons in the same layer and back-propagating action 1305 potentials can contribute to computations within the dendritic tree. FIG. 13 illustrates an exemplary two-neuron circuit incorporating these considerations. Each neuron 1309 j can process a visual stimulus 1301, 1303 u₃^{j}(x,y,t) using a distinct spatiotemporal receptive field 1315 h₃^{1j1}(x,y,t), j=1, 2. Furthermore, the processing of lateral inputs can be described by the temporal receptive fields (cross-feedback filters) h²²¹ and h²¹², while various signals produced by back-propagating action potentials are modeled by the temporal receptive fields (feedback filters) h²¹¹ and h²²². The aggregate dendritic currents v¹ and v², produced by the receptive fields and affected by back propagation and cross-feedback, can be encoded by IAF neurons into spike times (tₖ¹)_{kεZ}, (tₖ²)_{kεZ}.

In an exemplary theorem to describe SISO Multidimensional CIM with Lateral Connectivity and Feedback, {[uₙ^{1,i},uₙ^{2,i}]uₙ^{j,i}εHₙ, j=1,2}ᵢ₌₁^{N} be a collection of N linearly independent vector stimuli at the input to two neurons 1309 with multidimensional receptive fields 1315 hₙ^{1j1}εHₙ, j=1, 2, lateral receptive fields 1307 h²¹², h²²¹ and feedback receptive fields 1305 h²¹¹ and h²²². Let (tₖ¹)_{kεZ} and (tₖ²)_{kεZ} be sequences of spike times 1311, 1313 produced by the two neurons. For purposes of illustration, if the number of signals N≧Πₚ₌₁ⁿ⁻¹(2Lₚ+1)+2 and the total number of spikes produced by each neuron in response to all stimuli is greater than Πₚ₌₁ⁿ(2Lₚ+1)+2(2Lₙ+1)+N, then the filter projections Ph²¹¹, Ph²¹², Ph²²¹, Ph²²² and Phₙ^{1j1}, j=1, 2, can be identified as (Ph²¹¹)(t)=Σ_{l=-L}_{ₙ}^{L}^{ₙ}hₗ²¹¹eₗ(t), (Ph²¹²)(t)=Σ_{l=-L}_{ₙ}^{L}^{ₙ}hₗ²¹²e^{l}(t), (Ph²²¹)(t)=Σ_{l=-L}_{ₙ}^{L}^{ₙ}hₗ²²¹eₗ(t) (Ph²²²)(t)=Σ_{l=- L}_{ₙ}^{L}^{ₙ}h²²²eₗ(t) and

$$( {Ph}_{n}^{\vert j \vert} ) ( {x}_{1} , … , {x}_{n - 1} , t ) = {\sum }_{\vert {l}_{1} \vert \leq {L}_{1}} … {\sum }_{\vert {l}_{n} \vert \leq {L}_{n}} {h}_{{l}_{1} {l}_{2} … {l}_{n}}^{\vert j \vert} {e}_{{l}_{1} {l}_{2} … {l}_{n}} ( {x}_{1} , … , {x}_{n - 1} , t ) . \qquad ( 42 )$$

Here, the coefficients hₗ²²¹, hₗ²¹², hₗ²²¹, hₗ²²² and hₗ^{1j1} can be given by h=[Φ₁;Φ₂]⁺q with

q=[q¹¹, . . . , q^{1N},q²¹, . . . , q^{2N}]^{T},[q^{ji}]ₖ=qₖ^{ji} and h=[h¹;h²], where

h^{j}=[h_{-L}_{ₙ}_{, . . . , -L}_{ₙ}^{1j1}, . . . , h_{L}_{ₙ}_{, . . . , L}_{ₙ}^{1j1},h_{-L}^{2[(j mod 2)+1]j}, . . . , h_{L}^{2[(j mod 2)+1]j},h_{-L}^{2jj}, . . . , h_{L}^{2jj}]^{T}, j=1,2, (43)

provided each matrix Φⱼ has rank r(Φⱼ)=Πₚ₌₁ⁿ(2Lₚ+1)+2(2Lₙ+1). The i^{th} row of Φⱼ is given by [Φⱼ¹ⁱ,Φⱼ²ⁱ,Φⱼ³ⁱ], i=1, . . . , N, with

$$\begin{matrix}{[ {Φ}_{j}^{2 i} ]}_{kl} = \sqrt{T} {\int }_{{t}_{k}^{ji}}^{{t}_{k + 1}^{ji}} {t}_{l}^{[ ( j mod 2 ) + 1 ] i} {e}_{l} ( t ) exp ( \frac{{t}_{k}^{i} - {t}_{k + 1}^{i}}{RC} ) d t \\ and & ( 44 ) \\ {[ {Φ}_{j}^{3 i} ]}_{kl} = \sqrt{T} {\int }_{{t}_{k}^{ji}}^{{t}_{k + 1}^{ji}} {t}_{l}^{ji} {e}_{l} ( t ) exp ( \frac{{t}_{k}^{i} - {t}_{k + 1}^{i}}{RC} ) d t , & ( 45 )\end{matrix}$$

l=−Lₙ, . . . , Lₙ. The entries [Φⱼ¹ⁱ]ₖₗ are as described in the exemplary theorem.

For purposes of illustration, an exemplary proof is illustrated with an addition of lateral and feedback terms. In this example, each additional temporal filter can require (2Lₙ+1) additional measurements, corresponding to the number of bases in the temporal variable t.

### EXAMPLE 13

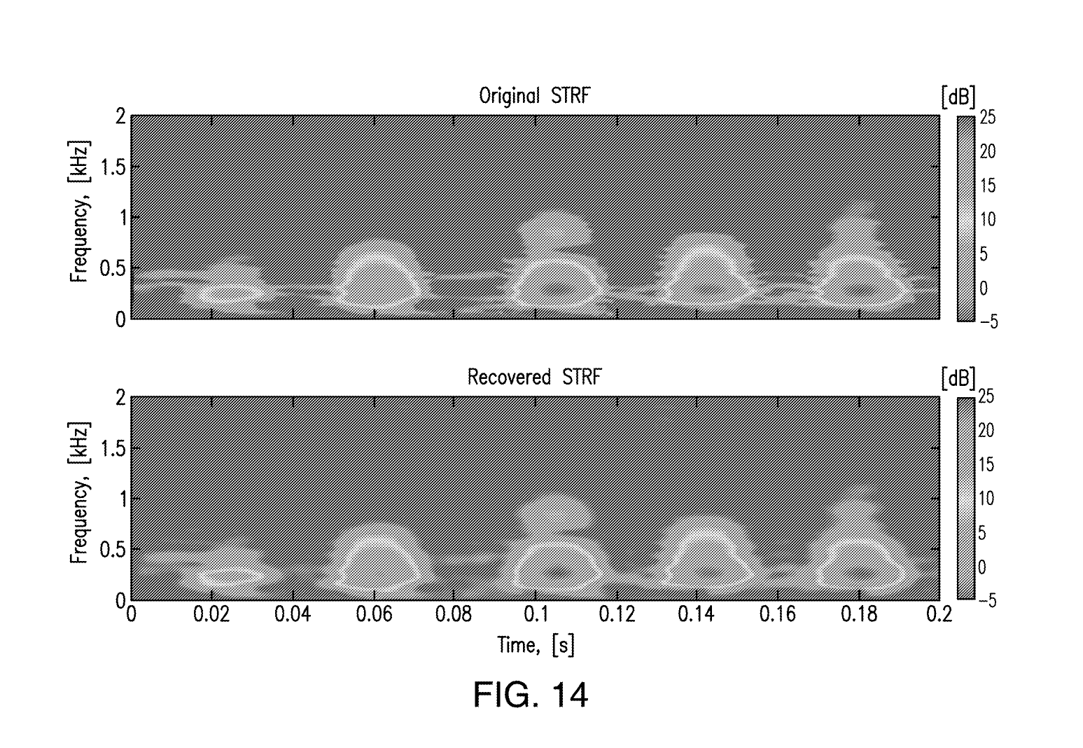

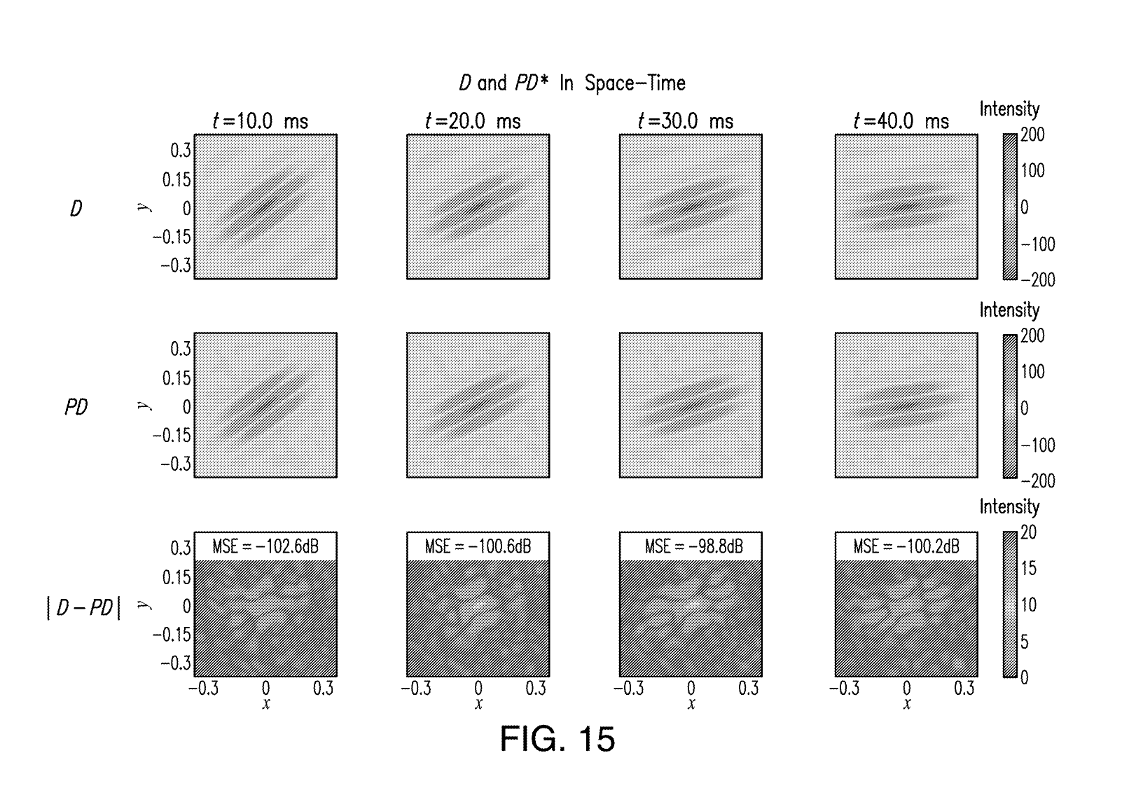

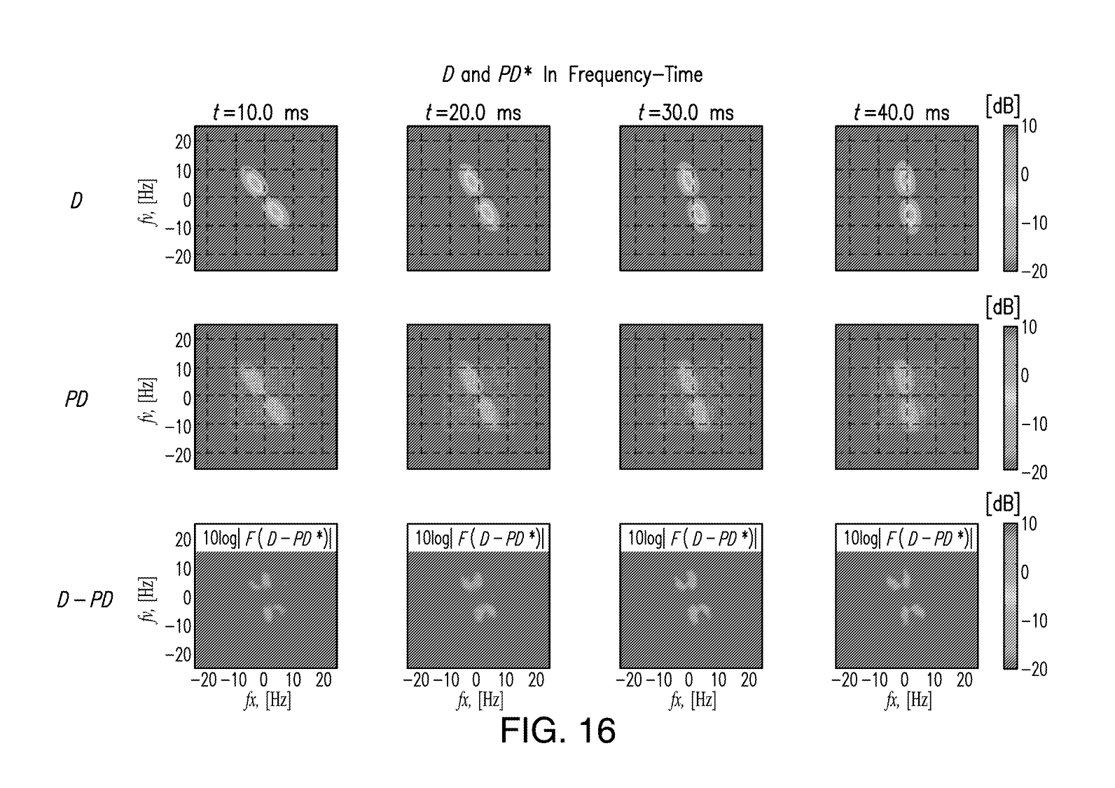

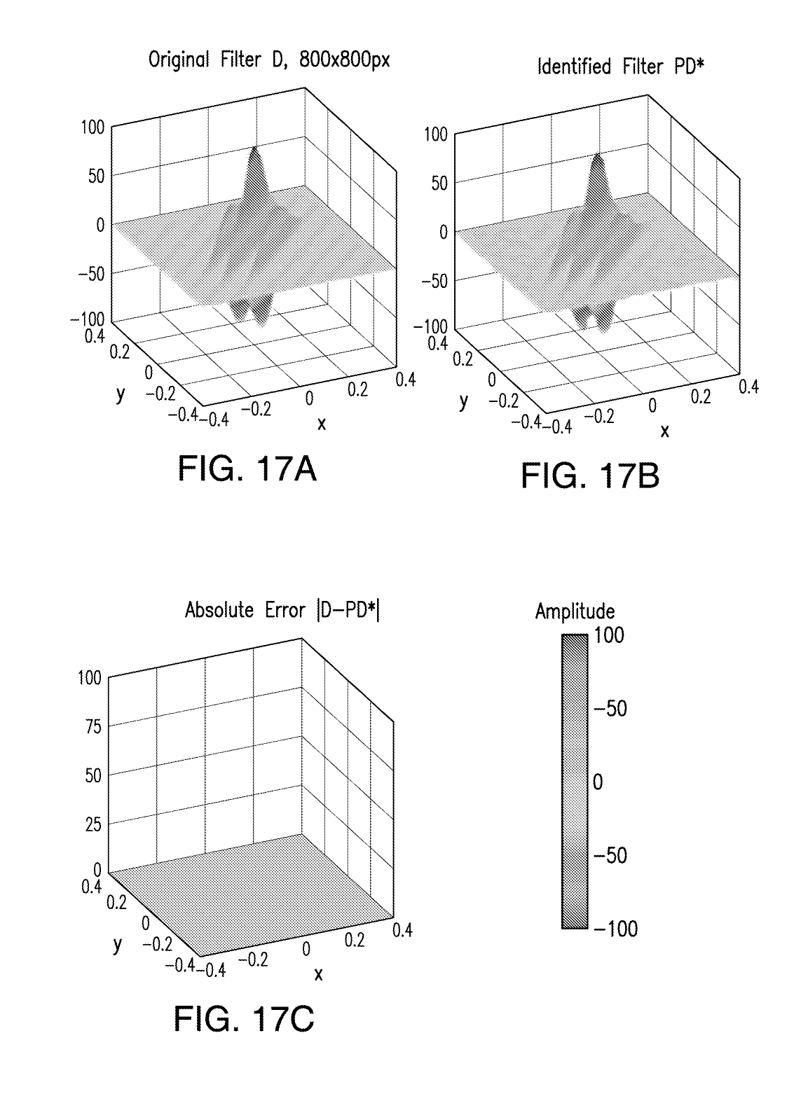

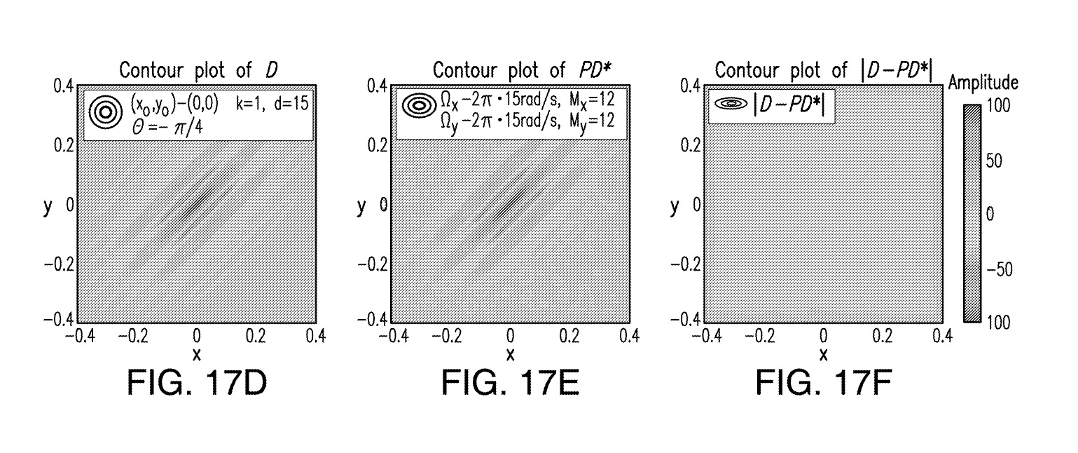

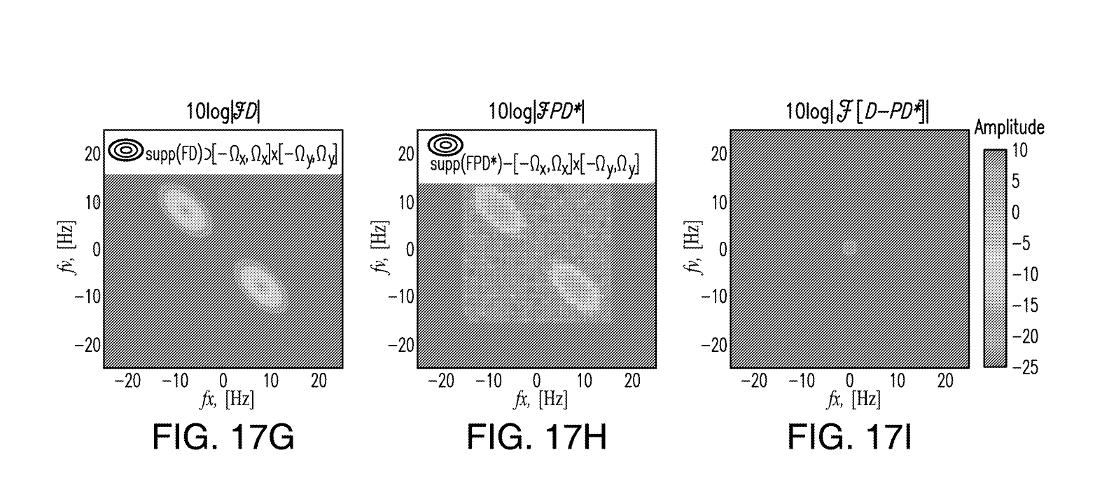

For purposes of illustration, FIG. 14, FIG. 15, FIG. 16, and FIGS. 17A-17I illustrate exemplary performance of an exemplary multidimensional Channel Identification Machine in accordance with the disclosed subject matter.

FIG. 14 illustrates performance of an exemplary spectro-temporal CIM in accordance with the disclosed subject matter. As further illustrated in FIG. 14, the original and identified spectrotemporal filters are shown in the top and bottom plots, respectively. Ω₁=2π·80 rad/s, L₁=16, Ω₂=2π·120 rad/s, L₂=24. For purposes of illustration, the short-time Fourier transform of an arbitrarily chosen 200 ms segment of the Drosophila courtship song is used as a model of the STRF. In this example, the space of spectrotemporal signals H₂ has bandwidth Ω₁=2π·80 rad/s and order L₁=16 in the spectral direction v and bandwidth Ω₂=2π·120 rad/s and order L₂=24 in the temporal direction t. Furthermore, in this example, the STRF appears in cascade with an ideal IAF neuron, as illustrated in FIG. 11, whose parameters are chosen so that it generates a total of more than (2L₁+1)(2L₂+1)=33×49=1,617 measurements in response to all test signals. In this example, a total of N=40 spectrotemporal signals are used, which is larger than the (2L₁+1)=33 requirement of exemplary theorem disclosed herein, in order to identify the STRF.

FIG. 15 illustrates performance of an exemplary spatio-temporal CIM in accordance with the disclosed subject matter. The top row of FIG. 15 illustrates exemplary Four frames of the original spatiotemporal kernel h₃(x,y,t). In this example, h₃ can be a spatial Gabor function rotating clockwise in space with time. The middle row of FIG. 15 illustrates an exemplary four frames of the identified kernel. Ω₁=2π·12 rad/s, L₁=9, Ω₂=2π·12 rad/s, L₂=9, Ω₃=2π·100 rad/s, L₃=5. The bottom row of FIG. 15 illustrates an exemplary absolute error between four frames of the original and identified kernel.

FIG. 16 illustrates performance of an exemplary spatio-temporal CIM in accordance with the disclosed subject matter. The top row of FIG. 16 illustrates an exemplary Fourier amplitude spectrum of the four frames of the original spatiotemporal kernel h₃(x,y,t) as illustrated in FIG. 14. In this example, the frequency support can be roughly confined to a square [−10,10]×[10,10]. The middle row of FIG. 16 illustrates an exemplary Fourier amplitude spectrum of the four frames of the identified spatiotemporal kernel as illustrated in FIG. 14. Nine spectral lines (L₁=L₂=9) in each spatial direction can cover the frequency support of the original kernel. The bottom row of FIG. 16 illustrates an exemplary absolute error between four frames of the original and identified kernel. As FIG. 16 further illustrates, in simulations involving the spatial receptive field, a static spatial Gabor function is used in one example. In this example, the space of spatial signals H₂ has bandwidths Ω₁=Ω₂=2π·15 rad/s and L₁=L₂=12 in spatial directions x and y. As seen in FIG. 12A and FIG. 12B, the STRF in this example appears in cascade with an ideal IAF neuron, whose parameters are chosen so that it generates a total of more than (2L₁+1)(2L₂+1)=25×25=625 measurements in response to all test signals. For purposes of illustration and to identify the projection, Ph₂ a total of N=688 spatial signals are used, which is larger than the (2L₁+1)(2L₂+1)=625 requirement of an exemplary theorem described herein.

FIGS. 17A-17I illustrate performance of a spatial CIM in accordance with the disclosed subject matter. As further illustrated in FIGS. 17A-17I, Ω₁=Ω₂=2π·15 rad/s, L₁=L₂12. For purposes of illustration, a minimum of N=625 images can be required for identification. In this example, 1.1×N=688 images were used. FIGS. 17A-17C illustrate an exemplary (FIG. 17A) original spatial kernel h₂(x,y), (FIG. 17B) identified kernel and (FIG. 17C) absolute error between the original spatial kernel the identified kernel. FIGS. 17D-17F illustrate an exemplary contour plots (FIG. 17D) of the original spatial kernel h₂(x,y), (FIG. 17E) identified kernel and (FIG. 17F) absolute error between the original spatial kernel and the identified kernel. FIGS. 17G-17I illustrate Fourier amplitude spectrum of signals in FIGS. 17D-17F, respectively.

For purposes of illustration, in simulations involving the spatiotemporal receptive field, which can be also illustrated in FIG. 14 and FIG. 15, a spatial Gabor function is used that is either rotated, dilated or translated in space as a function of time. Furthermore, the space of spatiotemporal signals H₃ has a bandwidth Ω₁=2π·12 rad/s and order L₁=9 in the spatial direction x, bandwidth Ω₂=2π·12 rad/s and order L₂=9 in the spatial direction y, and bandwidth Ω₃=2π·100 rad/s and order L₃=5 in the temporal direction t. In one example, the STRF is in cascade with an ideal IAF neuron as illustrated in FIG. 12A and FIG. 12B, whose parameters are chosen so that it can generate a total of more than (2L₁+1)(2L₂+1)(2L₃+1)=19×19×11=3,971 measurements in response to all test signals. For purposes of illustration and to identify the projection Ph₃ a total of N=400 spatiotemporal signals are used in this example, which is larger than the (2L₁+1)(2L₂+1)=361 requirement the exemplary theorem described herein.

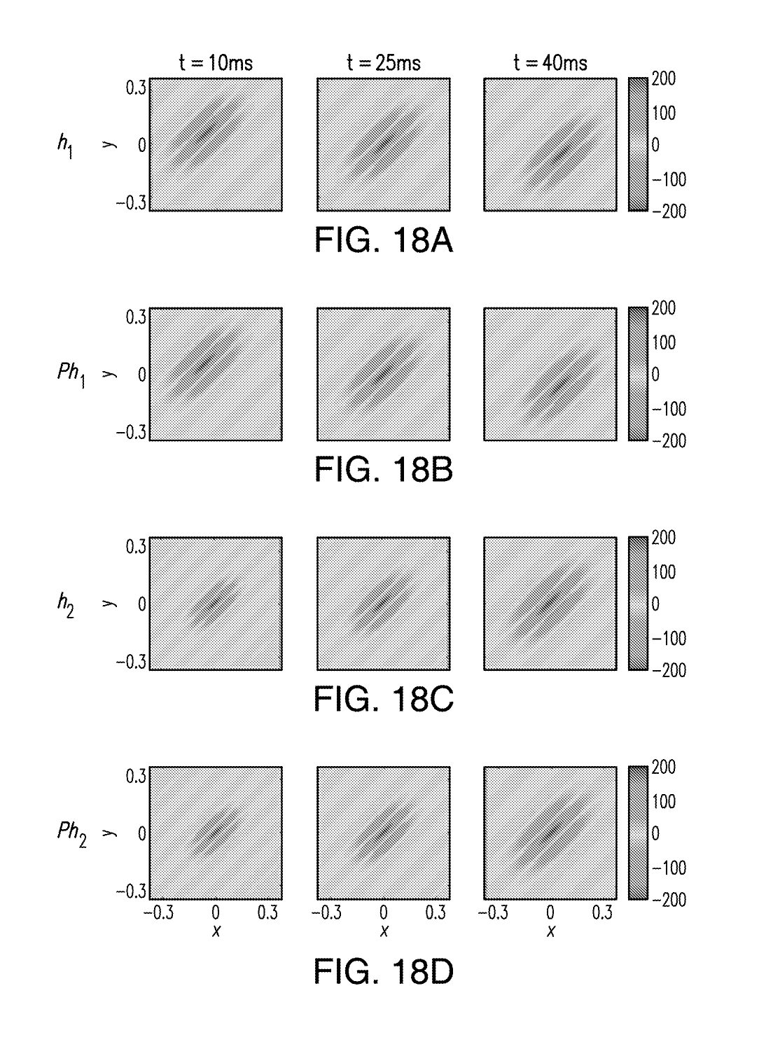

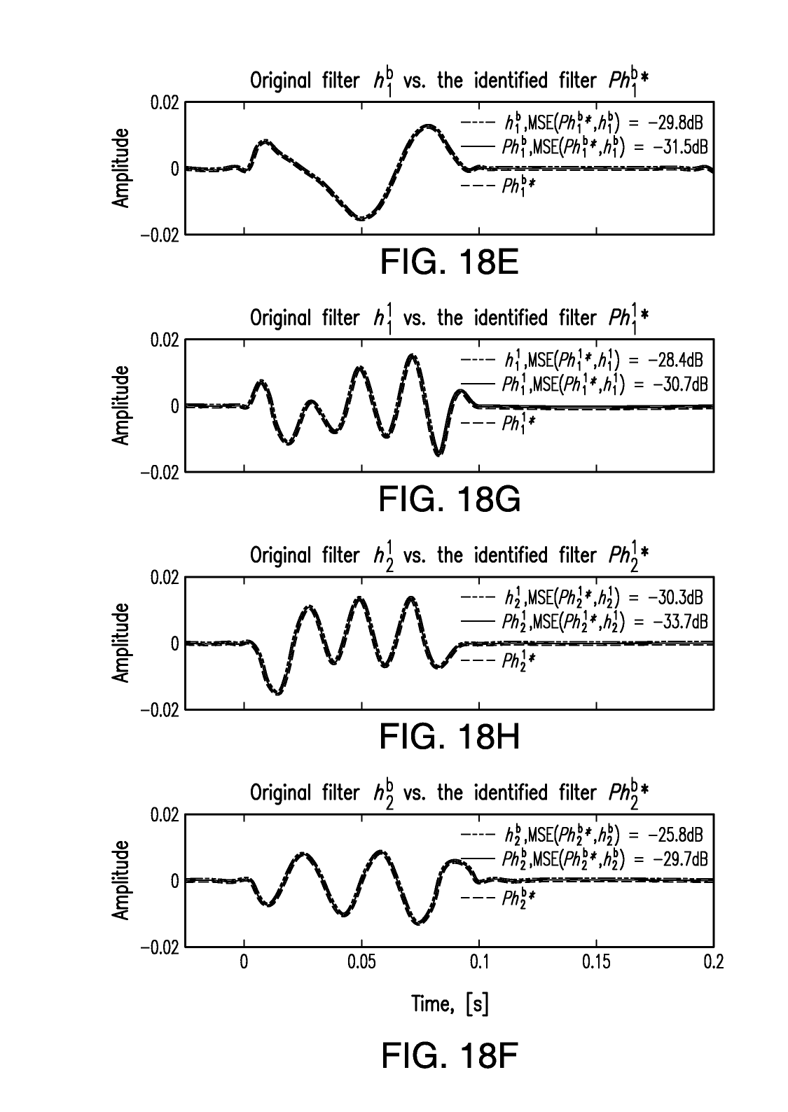

FIGS. 18A-18H illustrate an exemplary identification of spatiotemporal receptive fields in circuits with lateral connectivity and feedback. FIG. 18A, FIG. 18B, FIG. 18C, and FIG. 18D illustrate an exemplary identification of the feedforward spatiotemporal receptive fields of FIG. 13. FIG. 18E, FIG. 18F, FIG. 18G, and FIG. 18H illustrate an exemplary identification the lateral connectivity and feedback filters of FIG. 13. In one example, identification results for the circuit illustrated in FIG. 13 can be seen in FIGS. 18A-18H. As FIGS. 18A-18H illustrate, the spatiotemporal receptive fields used in this simulation are non-separable. The first receptive field is modeled as a single spatial Gabor function (at time t=0) translated in space with uniform velocity as a function of time, while the second is a spatial Gabor function uniformly dilated in space as a function of time. Three different time frames of the original and the identified receptive field of the first neuron are shown in FIG. 18A and FIG. 18B, respectively. Similarly, three time frames of the original and identified receptive field of the second neuron are respectively plotted in FIG. 18C and FIG. 18D. The identified lateral and feedback kernels are visualized in plots illustrated in FIG. 18E, FIG. 18F, FIG. 18G, and FIG. 18H.

### DISCUSSION

As discussed herein, the duality between a multidimensional channel identification and a stimulus decoding can enable identification techniques for estimation of receptive fields of arbitrary dimensions and for example, certain conditions under which the identification can be made. As illustrated herein, there can be a relationship between the dual examples.

Additionally, certain techniques for video time encoding and decoding machines can provide for the necessary condition of having enough spikes to decode the video. In one example, this condition can follow from having to invert a matrix in order to compute the basis coefficients of the video signal. As illustrated herein, since the matrix can be full rank to provide a unique solution, and there are a total of (2L₁+1)(2L₂+1)(2L₃+1) coefficients involved, (2L₁+1)(2L₂+1)(2L₃+1)+N spikes can be needed from a population of N neurons (the number of spikes is larger than the number of needed measurements by N since every measurement q is computed between two spikes).

As illustrated herein, a necessary condition can provide information that the number of spikes must have been greater than (2L₁+1)(2L₂+1)(2L₃+1)+N if the video signal is to be recovered. However, in order to guarantee that the video can be recovered there needs to be a sufficient condition.

The sufficient condition can be derived by drawing comparisons between the decoding and identification examples. However, a receptive field is not necessarily estimable from a single trial, even if the neuron produces a large number of spikes. For example, this can be because the output of the receptive field is just a function of time. As such, all dimensions of the stimulus can be compressed into just one the temporal dimension and (2L₃+1) measurements can be needed to specify a temporal function. As such, (2L₃+1) measurements can be informative and new information can be if the neuron is oversampling the temporal signal. Thus, as illustrated herein, if the neuron is producing at least (2L₃+1) measurements per each test stimulus, N≧(2L₁+1)(2L₂+1) different trials can be needed to reconstruct a (2L₁+1)(2L₂+1)(2L₃+1)-dimensional receptive field. Similarly, to decode a (2L₁+1)(2L₂+1)(2L₃+1)-dimensional input stimulus, N≧(2L₁+1)(2L₂+1) neurons can be needed, with each neuron in the population producing at least (2L₃+1) measurements. If each neuron produces less than (2L₃+1) measurements, a larger population N can be needed to faithfully encode the video signal.

As discussed herein, in one example, if the n-dimensional input stimulus is an element of a (2L₁+1)(2L₂+1) . . . (2Lₙ+1)-dimensional RKHS, where the last dimension is time, and the neuron is producing at least at least (2Lₙ+1)+1 spikes per test stimulus, a minimum of (2L₁+1)(2L₂+1) . . . (2Lₙ₋₁+1) different stimuli, or trials, can be needed to identify the receptive field. This condition can be sufficient and by duality between channel identification and time encoding, can complement the previous necessary condition derived for time decoding machines.

As discussed herein, the systems and methods according to the disclosed subject matter can be generalizable and scalable. For purposes of illustration, the disclosed subject matter can assume that the input-output system was noiseless. It should be understood that noise can be introduced in the disclosed subject matter, for example, either by the channel or the sampler itself. In the presence of noise, the identification of the projection Phₙ loss-free is not necessarily achievable. However, as discussed herein, the disclosed subject matter described herein can be used and extended within an appropriate mathematical setting to input-output systems with noisy measurements. For example, an optimal estimate Phₙ* of Phₙ can still be identified with respect to an appropriately defined cost function, e.g., by using the Tikhonov regularization method. The regularization methodology can be adopted with minor modifications.

As discussed herein, for purposes of illustration, the asynchronous encoder can be used. It should be understood that the asynchronous encoder can be a IAF neuron. It should also be understood that the asynchronous encoder can be known as a asynchronous sampler.

As discussed herein, the systems and methods according to the disclosed subject matter can enable a spiking neural circuit for multisensory integration that can encode multiple information streams, e.g., audio and video, into a single spike train at the level of individual neurons. As discussed herein, conditions can be derived for inverting the nonlinear operator describing the multiplexing and encoding in the spike domain and developed methods for identifying multisensory processing using concurrent stimulus presentations. As discussed herein, exemplary techniques are described for multisensory decoding and identification and their performance has been evaluated using exemplary natural audio and video stimuli. As discussed herein, there can be a duality between identification of multisensory processing in a single neuron and the recovery of stimuli encoded with a population of multisensory neurons. As illustrated herein, the exemplary techniques and RKHSs that have been used can be generalized and extended to neural circuits with noisy neurons.

As discussed herein, the exemplary techniques can enable biophysically-grounded spiking neural circuit and a tractable mathematical methodology together to multisensory encode, decode, and identify within a unified theoretical framework. The disclosed subject matter can be comprised of a bank of multisensory receptive fields in cascade with a population of neurons that implement stimulus multiplexing in the spike domain. It should be understood that as discussed herein, the circuit architecture can be flexible in that it can incorporate complex connectivity and a number different spike generation models. As discussed herein, the systems and methods according to the disclosed subject matter can be generalizable and scalable.

In one example, the disclosed subject matter can use the theory of sampling in Hilbert spaces. The signals of different modalities, having different dimensions and dynamics, can be faithfully encoded into a single multidimensional spike train by a common population of neurons. Some benefits of using a common population can include (a) built-in redundancy, whereby, by rerouting, a circuit can take over the function of another faulty circuit (e.g., after a stroke) (b) capability to dynamically allocate resources for the encoding of a given signal of interest (e.g., during attention) (c) joint processing and storage of multisensory signals or stimuli (e.g., in associative memory tasks).

As discussed herein, each of the stimuli processed by a multisensory circuit can be decoded loss-free from a common, unlabeled set of spikes. These conditions can provide clear lower bounds on the size of the population of multisensory neurons and the total number of spikes generated by the entire circuit. In one example, the identification multisensory processing using concurrently presented sensory stimuli can be performed according to the disclosed subject matter. As illustrated herein, the identification of multisensory processing in a single neuron can be related to the recovery of stimuli encoded with a population of multisensory neurons. Furthermore, a projection of the circuit onto the space of input stimuli can be identified using the disclosed subject matter. The disclosed subject matter can also enable examples of both decoding and identification techniques and their performance can be demonstrated using natural stimuli.

The disclosed subject matter can be implemented in hardware or software, or a combination of both. Any of the methods described herein can be performed using software including computer-executable instructions stored on one or more computer-readable media (e.g., communication media, storage media, tangible media, or the like). Furthermore, any intermediate or final results of the disclosed methods can be stored on one or more computer-readable media. Any such software can be executed on a single computer, on a networked computer (such as, via the Internet, a wide-area network, a local-area network, a client-server network, or other such network, or the like), a set of computers, a grid, or the like. It should be understood that the disclosed technology is not limited to any specific computer language, program, or computer. For instance, a wide variety of commercially available computer languages, programs, and computers can be used.

A number of embodiments of the disclosed subject matter have been described. Nevertheless, it will be understood that various modifications can be made without departing from the spirit and scope of the disclosed subject matter. Accordingly, other embodiments are within the scope of the claims.

1) A method of encoding one or more input signals, wherein the one or more input signals comprise one or more dimensions, comprising:
receiving the one or more input signals;
processing the one or more input signals to provide a first output;
providing the first output to one or more asynchronous encoders; and
encoding the first output, at the one or more asynchronous encoders, to provide one or more encoded signals.

2) The method of claim 1, wherein the first output is a function of time.

3) The method of claim 1, wherein the processing further comprises:
generating a second output for each of the one or more input signals by processing each of the one or more input signals using a kernel; and
aggregating the second output for each of the one or more input signals from processing each of the one or more input signals to provide the first output.

4) The method of claim 1, wherein the one or more encoded signals is a sequence of time.

5) The method of claim 1, wherein the processing further comprises:
processing a first input signal from the one or more input signals into a first processing output; and
aggregating the first processing output with a second signal.

6) The method of claim 5, wherein the second signal is a second processing output from processing a second input signal from the one or more input signals.

7) The method of claim 5, wherein the second signal is a back propagation signal.

8) The method of claim 1, wherein the processing further comprises processing on one of the one or more dimensions.

9) The method of claim 1, wherein the processing further comprises processing on each of the one or more dimensions.

10) The method of claim 1, wherein the one or more asynchronous encoders can include at least one of conductance based model, oscillator with multiplicative coupling, oscillator with additive coupling, integrate-and-fire neuron, threshold and fire neuron, irregular sampler, analog to digital converter, Asynchronous Sigma-Delta Modulator (ASDM), pulse generator, time encoder, or pulse-domain Hadamard gate.

11) A method of decoding one or more encoded signals corresponding to one or more input signals, wherein the one or more input signals comprise one or more dimensions, comprising:
receiving the one or more encoded signals; and
processing the one or more encoded signals to produce one or more output signals, wherein the one or more output signals comprise one or more dimensions.

12) The method of claim 11, wherein the processing further comprises:
determining a sampling coefficient using the one or more encoded signals;
determining a measurement using one or more times of the one or more encoded signals;
determining a reconstruction coefficient using the sampling coefficient and the measurement; and
constructing the one or more output signals using the reconstruction coefficient and the measurement.

13) The method of claim 11, wherein the one or more encoded signals are encoded using an asynchronous encoder.

14) The method of claim 13, wherein the asynchronous encoder can include at least one of conductance based model, oscillator with multiplicative coupling, oscillator with additive coupling, integrate-and-fire neuron, threshold and fire neuron, irregular sampler, analog to digital converter, Asynchronous Sigma-Delta Modulator (ASDM), pulse generator, time encoder, or pulse-domain Hadamard gate.

15) The method of claim 11, wherein the one or more encoded signals is a sequence of time.

16) The method of claim 11, wherein the one or more encoded signals is an aggregate of one or more spike trains.

17) A method of identifying a processing performed by an unknown system using one or more encoded signals, wherein the one or more encoded signals are encoded from one or more known input signals, wherein the one or more known input signals comprise one or more dimensions, comprising:
receiving the one or more encoded signals;
processing the one or more encoded signals to produce one or more output signals, wherein the one or more output signals comprise one or more dimensions; and
comparing the one or more known input signals and the one or more output signals to identify the processing performed by the unknown system.

18) The method of claim 17, wherein the one or more encoded signals is a sequence of time.

19) The method of claim 17, wherein the one or more encoded signals are encoded using an asynchronous encoder.

20) The method of claim 19, wherein the asynchronous encoder can include at least one of conductance based model, oscillator with multiplicative coupling, oscillator with additive coupling, integrate-and-fire neuron, threshold and fire neuron, irregular sampler, analog to digital converter, Asynchronous Sigma-Delta Modulator (ASDM), pulse generator, time encoder, or pulse-domain Hadamard gate.
